(19) United States
(12) Patent Application Publication
(10) Pub. No.: US 2021/0174459 A1
(43) Pub. Date: Jun. 10, 2021

(54) METHOD AND SYSTEM FOR A FOOD SOCIO-TOURISTIC MEDIA WITH FOOD RECOGNITION CAPABILITY USING ARTIFICIAL INTELLIGENCE LAZY PREDICTOR, SOCIAL MEDIA, AND INCENTIVIZED GAMIFICATION

(71) Applicant: NGUYEN ANH NGUYEN, Ho Chi Minh (VN)

(72) Inventor: NGUYEN ANH NGUYEN, Ho Chi Minh (VN)

(73) Assignee: NGUYEN ANH NGUYEN, Ho Chi Minh (VN)

(21) Appl. No.: 16/703,871

(22) Filed: Dec. 5, 2019

(30) Foreign Application Priority Data
Dec. 5, 2019 (VN) 1-2019-06842

(51) Int. Cl. G06Q 50/00; G06Q 30/02; G06N 20/00

(52) U.S. Cl. CPC G06Q 50/01; G06N 20/00; G06Q 30/0239

(57) ABSTRACT

A method for food recognition and a system for a food socio-touristic media platform are disclosed that combines both artificial intelligence and human intelligence in a worldwide connected social media. The method and system include: a data center configured to store a set of known food dishes; a web server capable of launching the food socio-touristic media platform to a plurality of users; a computing engine further configured to receive food inputs from the plurality of users and perform an artificial intelligence lazy predictor algorithm to recognize the food inputs and related parameters; and the human intelligence from the worldwide connected social media is incentivized to recognize and teach the computing engine if the computing engine fails to recognize in the food inputs.

### FIELD OF THE INVENTION

The present invention relates generally to a social media platform. More specifically, the present invention relates to a food recognition method applicable in a food social media platform using artificial intelligence, human intelligence, and gamification.

### BACKGROUND ART

Today, artificial intelligence and machine learning have become very popular in many commercial and industrial applications such as E-commerce, chatbots, image search, customer data analytics, recommendation systems, inventory management, cybersecurity, after sales service, customer relationship management (CRM), and sales improvement. In food recognition, deep convolutional neural network (CNN) technologies have been used to identify unknown foods that have many applications in food industry and medicines.

However, the conventional artificial intelligence and deep learning in the CNN technologies are very limited since they can only identify 87% of a limited amount of dishes in a known region. When asked to recognize foods in different regions, artificial intelligence often fails to perform. For the vast varieties of foods around the world, the artificial intelligence cannot distinguish similar foods and beverages such as pho bo (Vietnamese beef noodle soup) with Chinese beef noddle soup, Vietnamese coffee and condensed milk and Italian cappuccino, etc.

No artificial intelligence (AI) is better than human intelligence, especially in the area of food image identification. This is particularly true when food experts, chefs, and food lovers around the world can participate in a social media to identify food images posted therein. As of today, no artificial intelligence system can accurately recognize the complex and rich foods from around the world. If there were one, it would have been a very large and expensive artificial intelligence system.

Therefore what is needed is method and system that can recognize a rich variety of foods around the world using both artificial intelligence, deep learning technology, and human intelligence from a social media.

What is needed is a social media that utilizes gamification to incentivize human intelligence to participate in the food recognition efforts.

What is needed is social media that can promote food tourism using artificial intelligence, deep learning technology, and human intelligence.

What is needed is an inexpensive and simple network that can recognize the complex and rich food dishes from around the world that can be used in different applications such as tourism, dietary science, etc.

### SUMMARY OF THE INVENTION

Accordingly, an object of the present invention is to provide a system for a food socio-touristic media platform and a method for food recognition that include: a data center configured to store a set of N known food dishes, each having M features, where N and M are a non-zero positive integers; a web server capable of launching the food socio-touristic media platform to a plurality of users; a computing engine further configured to receive food inputs from the plurality of users and perform a lazy predictor algorithm to recognize the food inputs and related parameters; and when the computing engine fails to identify the food inputs and related parameters, the computing engine receives answers from the plurality of users from the socio-touristic media platform and updates the group of N known food dishes as a deep learning mechanism.

Another object of the present invention is to provide a method of identifying unknown food dishes which includes: storing a set of N known food dishes in a database, each having M features, where N and M are non-zero positive integers; building a social media platform configured to connect a plurality of users together; calculating distances for the unknown food dishes and the N known food dishes in an M coordinate space formed by the M features; selecting only distances of the N known food dishes that are closest to those of unknown food dishes; if the distances of the N known food dishes that are closest to those of the unknown food dishes are undeterminable, posting the unknown food dishes in the social media asking the plurality of users to identify the unknown food dishes; and increasing the set of N known food dishes to include the unknown food dishes that are identified by the plurality of users.

Another object of the present invention is to provide a socio-touristic media platform that includes: a forum where a plurality of users are enabled to post questions regarding food inputs and related parameters which include similar food dishes, a group of users who also like those food inputs and similar food dishes, and restaurants that offer the food inputs and such similar food dishes; a social network where the plurality of users are enabled to maintain and update friend lists, to receive display options, and to notify alert options; a food tourism where the plurality of users are enabled to receive recommendations and/or receive answers from either the plurality of users or a computing engines; and a gamification where the plurality of users are incentivized to provide answers to the food inputs and related parameters.

Yet another object of the present invention is to combine both human intelligence and artificial intelligence in food recognition using a social media and deep learning algorithm.

### BRIEF DESCRIPTION OF THE DRAWINGS

The patent or application file contains a least one drawing executed in color. Copies of this patent or patent application publication with color drawing(s) will be provided by the Office upon request and payment of the necessary fee.

The accompanying drawings, which are incorporated in and form a part of this specification, illustrate embodiments of the invention and, together with the description, serve to explain the principles of the invention.

FIG. 1 is a flow chart illustrating a food recognition method using an artificial intelligence lazy predictor, a social media, gamification, and deep learning algorithm in accordance with an exemplary embodiment of the present invention;

FIG. 2 is a multi-dimension vector space illustrating the food recognition method that uses the artificial intelligence lazy predictor, social media, and incentivized gamification in accordance with an exemplary embodiment of the present invention;

FIG. 3 is a flow chart of the Hatto™ food socio-touristic media software program that utilizes the food recognition method described in FIG. 1 and FIG. 2 in accordance with an exemplary embodiment of the present invention;

FIG. 4 is an organization of the Hatto™ food socio-touristic media in accordance with an exemplary embodiment of the present invention;

FIG. 5 is a perspective schematic diagram of the Hatto™ food socio-touristic network in accordance with an exemplary embodiment of the present invention;

FIG. 6 is a flow chart of the input and search algorithm in the Hatto™ food socio-touristic media software program that utilizes the food recognition method described in FIG. 1 and FIG. 2 in accordance with an exemplary embodiment of the present invention;

FIG. 7 is a flow chart of the food tourism algorithm in the Hatto™ food socio-touristic media software program that utilizes the food recognition method described in FIG. 1 and FIG. 2 in accordance with an exemplary embodiment of the present invention;

FIG. 8 is a flow chart of the incentivized gamification in the Hatto™ food socio-touristic media software program that utilizes the food recognition method described in FIG. 1 and FIG. 2 in accordance with an exemplary embodiment of the present invention;

FIG. 9 is a flow chart of the dis-incentivized gamification in the Hatto™ food socio-touristic media software program that utilizes the food recognition method described in FIG. 1 and FIG. 2 in accordance with an exemplary embodiment of the present invention;

FIG. 10 a flow chart of the status algorithm in the Hatto™ food socio-touristic media software program that utilizes the food recognition method described in FIG. 1 and FIG. 2 in accordance with an exemplary embodiment of the present invention;

FIG. 11 illustrates a comprehensive hardware structure of the Hatto™ food socio-touristic media in accordance with an embodiment of the present invention;

FIG. 12A-FIG. 12B illustrate a log-in page and a personal page of the Hatto™ food socio-touristic media in accordance with an exemplary embodiment of the present invention;

FIG. 13A-FIG. 13B illustrate a camera application and food inputs in the Hatto™ food socio-touristic media in accordance with an exemplary embodiment of the present invention;

FIG. 14A-FIG. 14C illustrate the search result page and the forum page of the Hatto™ food socio-touristic media in accordance with an exemplary embodiment of the present invention;

FIG. 15A-FIG. 15C illustrate the recommendation pages of the Hatto™ food socio-touristic media in accordance with an exemplary embodiment of the present invention;

FIG. 16A-FIG. 16C illustrate the restaurant location recommendation pages of the Hatto™ food socio-touristic media in accordance with an exemplary embodiment of the present invention;

FIG. 17A-FIG. 17C illustrate the forum pages of the Hatto™ food socio-touristic media in accordance with an exemplary embodiment of the present invention;

FIG. 17A-FIG. 17C illustrate first-level prize (watermelons) rewarding and notification pages of the Hatto™ food socio-touristic media in accordance with an exemplary embodiment of the present invention;

FIG. 18A-FIG. 18C illustrate first-level prize awards in the gamification section of the Hatto™ food socio-touristic media in accordance with an exemplary embodiment of the present invention;

FIG. 19A-FIG. 19C illustrate prize exchange, reward status, and forum pages of the Hatto™ food socio-touristic media in accordance with an exemplary embodiment of the present invention;

FIG. 20A-FIG. 20C illustrate product purchasing pages of the Hatto™ food socio-touristic media in accordance with an exemplary embodiment of the present invention; and

FIG. 21A-FIG. 21C illustrate QR codes in the product purchasing pages of the Hatto™ food socio-touristic media in accordance with an exemplary embodiment of the present invention.

The figures depict various embodiments of the technology for the purposes of illustration only. A person of ordinary skill in the art will readily recognize from the following discussion that alternative embodiments of the structures and methods illustrated herein may be employed without departing from the principles of the technology described herein.

### DETAILED DESCRIPTION OF THE INVENTION

Reference will now be made in details to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in details so as not to unnecessarily obscure aspects of the present invention.

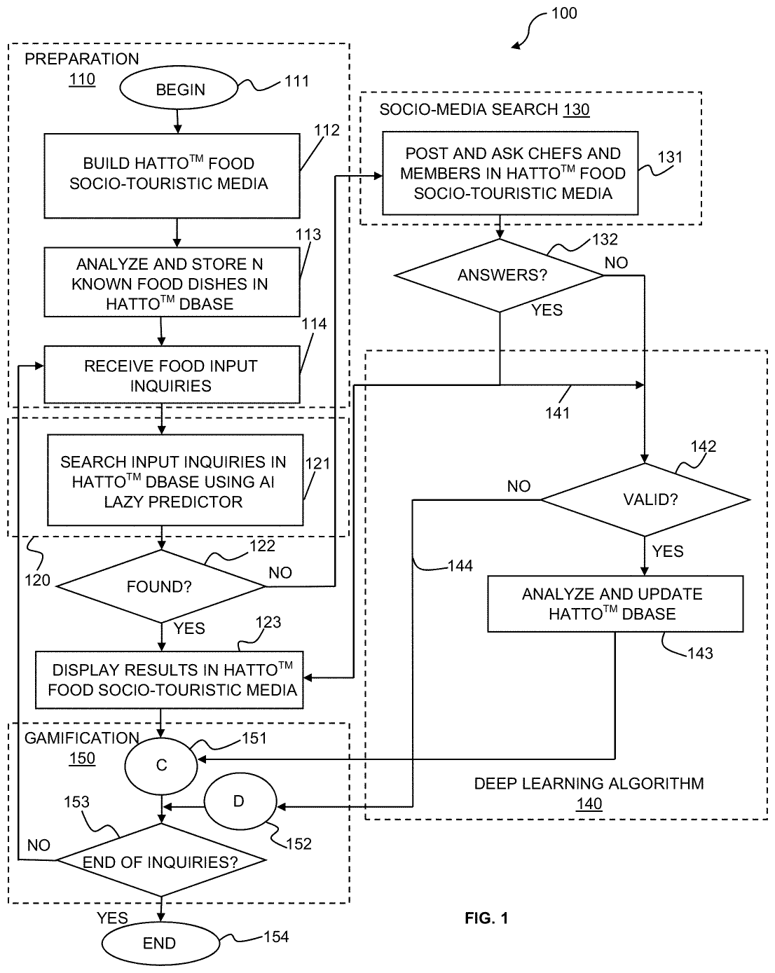

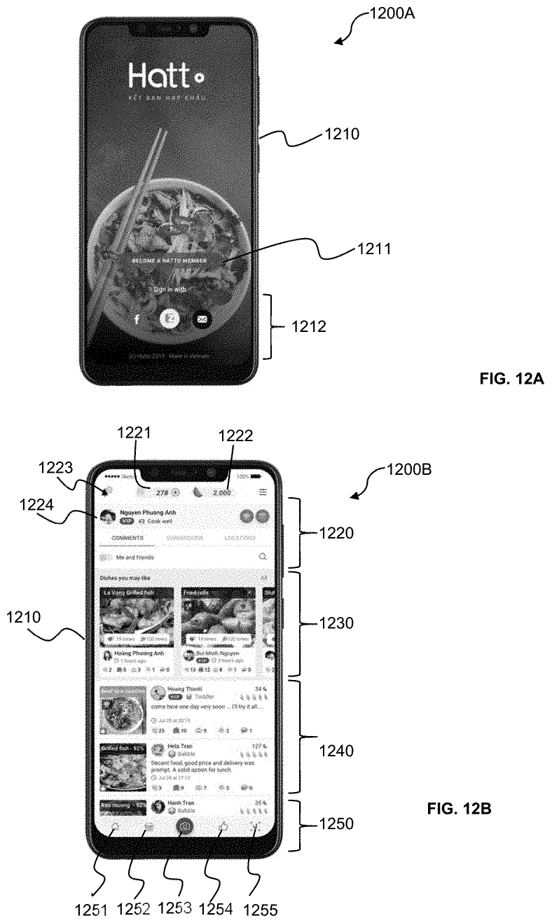

Exemplary embodiments and aspects of the present invention are now described with reference to FIGS. 1 to 21. The present disclosure discloses the following features of the present invention: (1) a system for rendering a socio-touristic media platform that uses the novel Hatto™ food recognition method, (2) a method for food recognition that uses artificial intelligence in combination with human intelligence in a social media (AI) lazy predictor and knowledge of the social media that provides deep learning platform supplemental to the AI lazy predictor, and (3) a socio-touristic media platform using (1) and (2) that can promote Hatto™ food tourism and social network. FIG. 1-FIG. 11 illustrate algorithms and system for the food socio-touristic media platform of the present invention. FIG. 12-FIG. 21 illustrate different display pages of the Hatto™ socio-touristic media platform as the results of (1)-(3) on a communication device.

Now referring to FIG. 1, FIG. 1 is a flow chart illustrating a food recognition method 100 using artificial intelligence (AI) lazy predictor, social media, incentivized gamification, and deep learning algorithm in accordance with an exemplary embodiment of the present invention. In a generalized structure of the present invention, food recognition method 100 includes 4 major components: a preparation step 110, an artificial intelligence search step 120, a social-media search step 130, a deep learning step 140, and a gamification step 150. That is, in essence, the present invention involves food recognition using artificial intelligence combined with human expert intelligence in a social-media incentivized by gamification aspect, and a deep learning algorithm using the human intelligence to assist and update the artificial intelligence step.

Preparation step 110 includes a begin step 111, a food socio-media building step 112, a database constructing step 113, and an input step 114.

First, at step 111, method 100 begins by preparing materials necessary to perform the subsequent steps of method 100. Preparatory materials include gathering known food dishes to teach the artificial intelligence. Materials include newspapers articles, cook books, recipes, documents, and/or expert opinions to train the machine learning algorithsm and to check the validity of food input inquiries; hardware and software to build the food socio-media; artificial intelligence system; and the deep learning algorithms.

At step 112, a food socio-touristic media is built. The food socio-touristic media is a dynamic and interactive website that allows users to make friends, submit food input inquiries, chat with friends in a forum, promote tourism, play games, etc. In an implementation of step 112, the food socio-touristic media is built using either WordPress, C++, Java, PHP, Pearl, or Python programming languages. In various embodiments of the present invention, the food socio-touristic media includes interactive or touchscreen displays which will be presented and described in FIG. 12-FIG. 21.

At step 113, a set of M known food dishes and their associated N features are stored in a database, where M and N are a non-zero positive integer numbers (M, NϵI⁺). In an exemplary embodiment of the present invention, M is chosen to be 327 and M be 1,792. That is, 1,792 features are selected from each dish among the 327 known food dishes. These 1,792 features are extracted from the analytical picture recognition categories such as color descriptors, texture descriptors, image segmentation, and food classification. First, in each known food dish, an image segmentation is performed by analyzing 1,000 images of a known food dish. Image segmentation is used to distinguish the components of each food dish. For example, a known cheeseburger and French fries dish shall include the buns, the burgers, cheese, salad, tomatoes, mayonnaise, onion, bacons, French fries, and other components such as ketchup. Each component has an edge region and interior region. Two components; i.e., the burgers and the buns; are segmented if the differences between the edge regions and the interior regions are large.

Continuing with step 113, after image segmentation is complete, food classification is performed. In some embodiments, four color descriptors namely Scalable Color Descriptor (SCD), Color Structure Descriptor (CSD), Dominant Color Descriptor (DCD), and Color Layout Descriptor (CLD) in MPEG-7 are used. SCD is a color histogram descriptor in HSV Color Space with a uniform quantization of the HSV space. CSD expresses local color structure in HMMD color space using an I by J scanning the image. HMMD color space includes hue, shade (max.), tint (min.), and brightness of a color (differential). DCD uses color clustering to extract a small number of representing colors and their percentages from a segmented region in the perceptually uniform CIE LUV color space. CLD is used to capture the spatial distribution of color in a segmented region. The segmented region is divided into small blocks. The average color of each block in YCrCb color space is calculated to form the descriptor.

Continuing with step 113, similar to color, texture is a very descriptive low-level feature for image search and matching applications. In the present invention, the following three texture descriptors for food classification are used: Gradient Orientation Spatial-Dependence Matrix (GOSDM), Entropy-Based Categorization and Fractal Dimension Estimation (EFD) and Gabor-Based Image Decomposition and Fractal Dimension Estimation (GFD). GOSDM consists of a set of gradient orientation spatial dependence matrices to describe the texture by the occurrence rate of the spatial relationship of gradient orientations for different neighborhood size. EFD is an attempt to characterize the variation of roughness of homogeneous parts of the texture in terms of complexity. In general regions of the image corresponding to high complexity (high level of detail) tend to have higher entropy, thus entropy can be seen as a measure of local signal complexity. Once the entropy is estimated for pixels in the texture image, the regions with similar entropy values are clustered to form a point categorization. The fractal dimension descriptor is, then, estimated for every point set according to this categorization. GFD is also based on fractal dimension. Instead of using entropy categorization, the image is decomposed into sub-images in its spatial frequency dimension using Gabor filter-bank which consists of a set of Gabor filters. The fractal dimension is estimated for each filtered response.

In the present invention, each segmented region is regarded as a stand-alone image by masking and zero padding the original image. After extracting color and texture features from a segmented region, a category label to the segment based on a majority vote rule of the nearest neighbors is assigned. The K nearest distances are calculated using the following formula:

$${d}_{0 , … , K - 1} ( {S}_{n} , i , f ) = {{min}_{i}}_{{}_{0} , … , K - 1} ‖ {φ}_{f} ( {S}_{n} ) - {φ}_{f} ( {I}_{i} ) ‖$$

Where Iᵢ is the known food dishes and n be the category index of the i^{th} known food, ϕ is the feature space, and Sₙ is the set the segmented objects in the known food dish, and d₀(Sₙ, i) is the minimum distance of the test segment sₙ to all the training images and the i-th image is the best match of Sₙ in the feature space ϕ_{f}.

As mentioned above, in the present invention, the proposed integrated image segmentation and classification method was tested on 500,000 food images with 327 unique food inputs. 1,792 features such as color quantization, segmentation, color descriptors, texture descriptors, hue, tint, shade, tone, brightness, etc. are extracted and used to calculate the nearest distances d₀(Sₙ, i).

At step 114, food input inquiries are received. In many embodiments of the present invention, food input inquiries can be images, text descriptions, and verbal descriptions. In various aspects of the present invention, 500,000 food articles are used to teach the artificial intelligence (AI) system to recognize the validity of each food input inquiries. The Term-Frequency Inverse Document Frequency (TF-IDF) text mining algorithm is used to check the validity of a food input inquiry.

In artificial intelligence searching step 120, food input inquiries are searched using artificial intelligence lazy predictor as described in step 113 above.

At step 121, the food input inquiries are searched using the AI lazy predictor as described in step 113. That is, the minimum distances d₀(Sₙ, i) are calculated for each food input inquiry. In many aspects of the present invention, the minimum distances are calculated using the Euclidean distance formula. In other aspects of the present invention, the minimum distances are the cosine similarity formula.

At step 122, whether the food input inquiries are found in the Hatto™ database using the artificial intelligence lazy predictor is determined. In many aspects of the present invention, if the minimum distances d₀(Sₙ, i) can be calculated, then the food input inquiries can be determined. Otherwise, if the calculation is indeterminable, then the food input inquiries cannot be determined by the artificial intelligence (AI) lazy predictor. In the present invention, the food recognition algorithm does not stop here. If the results cannot be calculated, method 100 goes to food socio-touristic media step 130.

At step 123, if the food input inquiries are found then the results and related parameters are displayed in the food socio-touristic media. In many aspects of the present invention, related parameters include, but not limited to, similar foods, friends or users that love the same food input inquiries or similar dishes, addresses and names of restaurants or users that can offer the same food input inquiries. In other aspects of the present invention, related parameters also include dietary, medical, and physiological analyses of the food input inquiries.

At step 130, if the minimum distances d₀(Sₙ, i) of the food input inquiries cannot be calculated, then method 100 goes to socio-media search step 130 which includes a specific step 131.

At step 131, food input inquiries are posted waiting for answers and related parameters from certified chefs and users in the food socio-tourist media. The more users register to use the food socio-touristic media, the larger variety of food dishes and related parameters can be identified.

At step 132, if the solicited answers that identify the food input inquiries and related parameters are found, method 100 goes into deep learning step 140 to teach and train the artificial intelligence lazy predictor.

From steps 141-143, the socio-touristic media platform deep learning begins.

At steps 141 and 142, if the answers are found, the answers are checked for validity using the Term-Frequency Inverse Document Frequency (TF-IDF) text mining algorithm of step 114. This is because many answers from the food socio-touristic media may contain illicit content unrelated to the food input inquiries.

At step 143, if the answers are valid, then the answers are updated in the Hatto™ food database by analyzing the food input inquiry as described in step 113. The name of the food input inquiry, its M=1,792 features, the related parameters are stored as training food dishes for the lazy predictor. For example, if the food input inquires include two dishes. The set of N known food dishes is increased to N+2 known food dishes. Finally, the valid answers are posted in the food socio-touristic media as in step 123.

At step 144, if the answers are not found by the users and chefs in the food socio-touristic media, then the validity of the input is again checked using the Term-Frequency Inverse Document Frequency (TF-IDF) text mining algorithm of step 114. As an illustrating example, if the food input inquiries contain illicit content that has nothing to do with foods, both the TF-IDF of artificial intelligence system and the socio-media will reject and block the answers.

After the validity is determined, the gamification step 150 begins to incentivize users and chefs to participate in the food recognition of the Hatto™ food socio-touristic media.

At step 151, if the answers are valid then rewarding gamification C begins.

At step 152, if the answers are invalid then the deterring or punishing gamification D begins. The detailed description of rewarding gamification C and deterring gamification D will be described later in the present disclosure.

At step 153, determine if the users post another food input inquires.

At step 154, if there are no other food input inquires then method 100 ends. If there are other food input inquires then repeats steps 111-153.

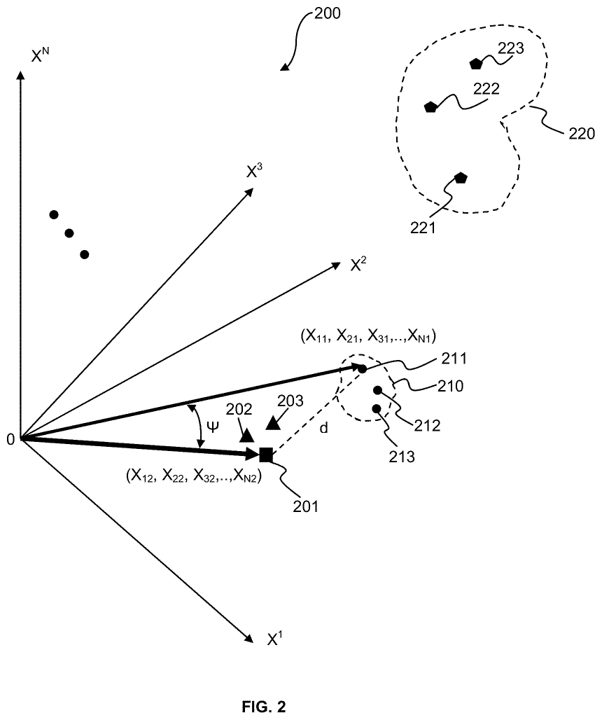

Now referring to FIG. 2, FIG. 2 is a N-dimension vector space 200 illustrating food recognition method 100 that uses the artificial intelligence (AI) lazy predictor, social media, gamification, and incentivized gamification in accordance with an exemplary embodiment of the present invention. N-dimension vector space 200 formed by the set of N features of each known food dish includes X¹ to X^{N} axes. The food input inquiry represented by a square symbol 201 having N features represented by coordinates (X₁₂, X₂₂, X₃₂, . . . , X_{N2}). i-th known food dishes that has the minimum Euclidean distances to square symbol 201 are represented by triangular points 210, 211, 212, and 213. In many aspects of the present invention, the minimum Euclidean distances are calculated using the following formula:

$${d}_{0 , … , K - 1} ( {S}_{n} , i , f ) = {{min}_{i}}_{{}_{0} , … , K - 1} ‖ {φ}_{f} ( {S}_{n} ) - {φ}_{f} ( {I}_{i} ) ‖$$

Food dishes represented by triangular points 202 and 203 that are found by the lazy predictor using formula 1 are the implementations of step 123. Related parameters that are same or complementary food dishes 210 are represented by circular points 211-213. Food input inquiries that cannot be determined by the lazy predictor are represented by polygon points including points 220, 221, 222, and 223. This is when socio-media search step 130 and deep learning step 140 above take place. Such food input inquiries are posted in the food socio-touristic media platform to solicit answers from the community of users and certified chefs, which is illustrated by step 131. If the answers are provided from the food socio-touristic media platform, food dishes 221, 222, and 223 are analyzed and learned as described in step 113. After learning and analyses, these food dishes 221, 222, and 223 are added to the set of M known food dishes, which implements steps 141 to 143.

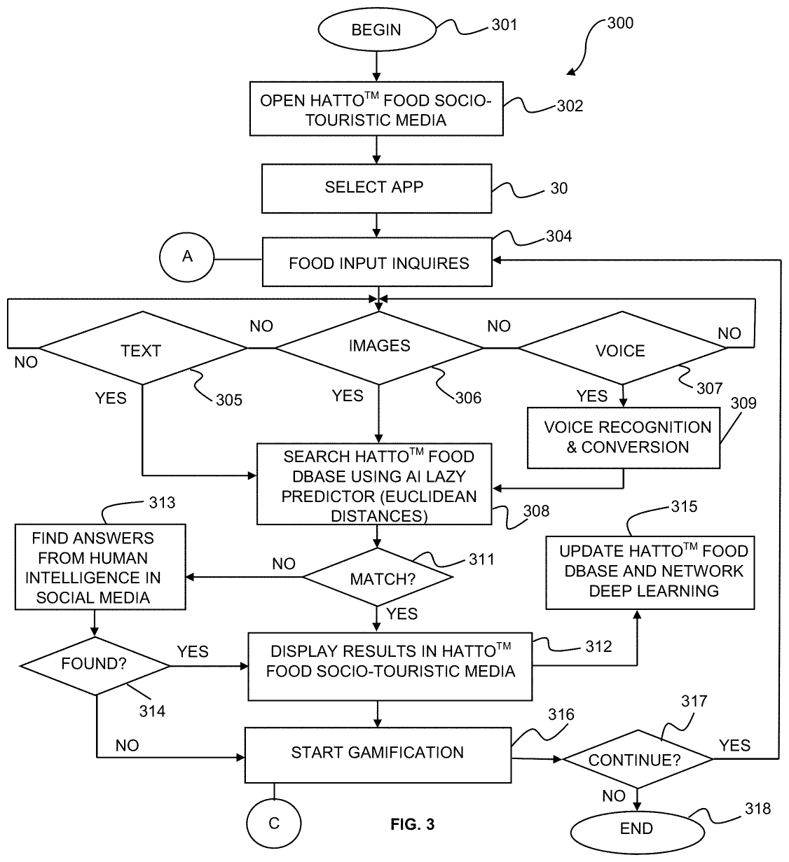

FIG. 3 is a flow chart of a Hatto™ food socio-touristic media software program 300 (“software program 300”) that utilizes the food recognition method described in FIG. 1 and FIG. 2 in accordance with an exemplary embodiment of the present invention. Again, software program 300 involves artificial intelligence searching, food socio-touristic media searching, deep learning, and gamification as discussed above in FIG. 1 and FIG. 2.

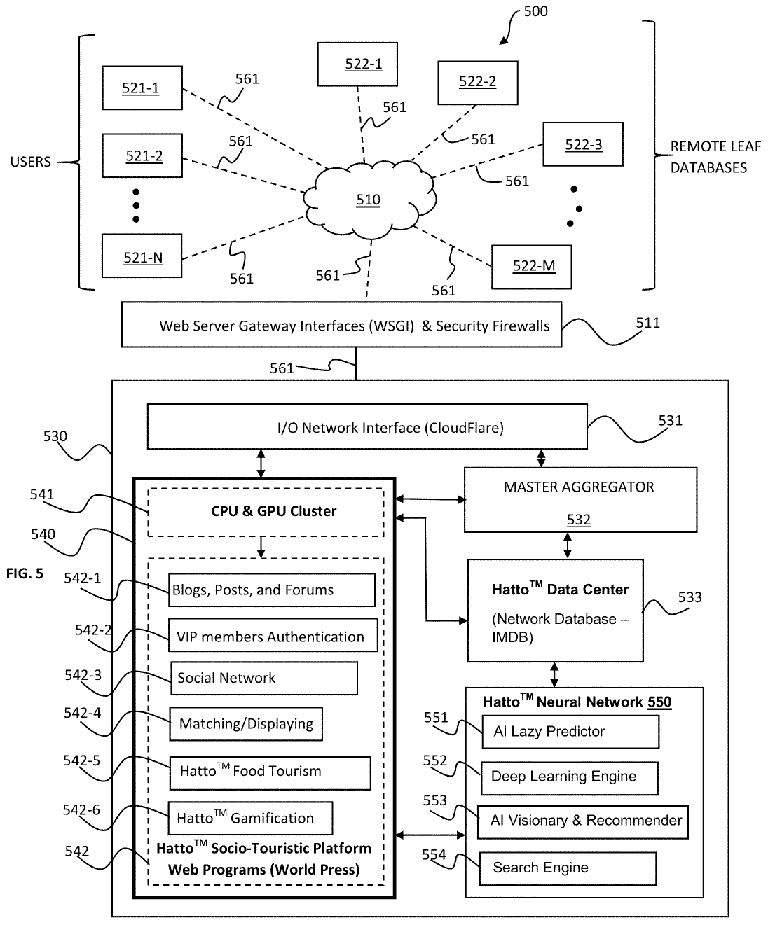

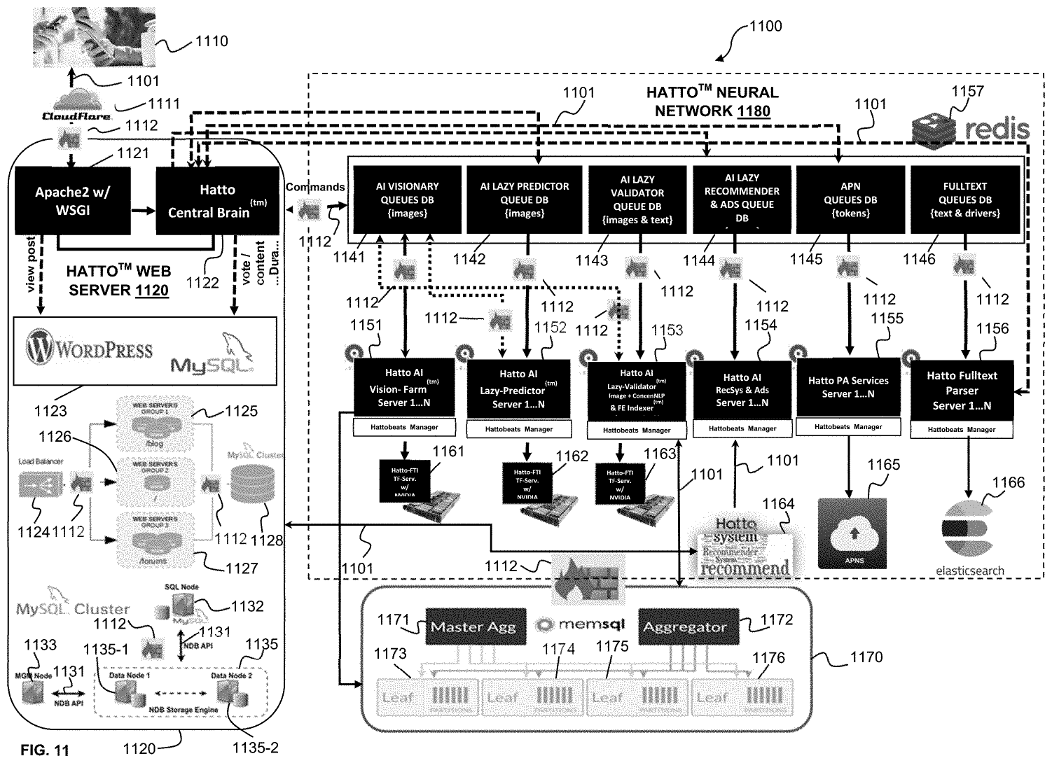

At step 301, the software program begins. Step 301 is implemented by clicking on an icon that causes software program to be executed by a cluster of central processing units (CPU). The hardware and software implementation of step 301 will be described in details later in FIG. 5 and FIG. 11. When a user is registered to use the Hatto™ food socio-touristic media, an icon (or graphic user interface or GUI) is downloaded to his or her cell phone. Please refer to FIG. 12 for an illustration of this icon or GUI.

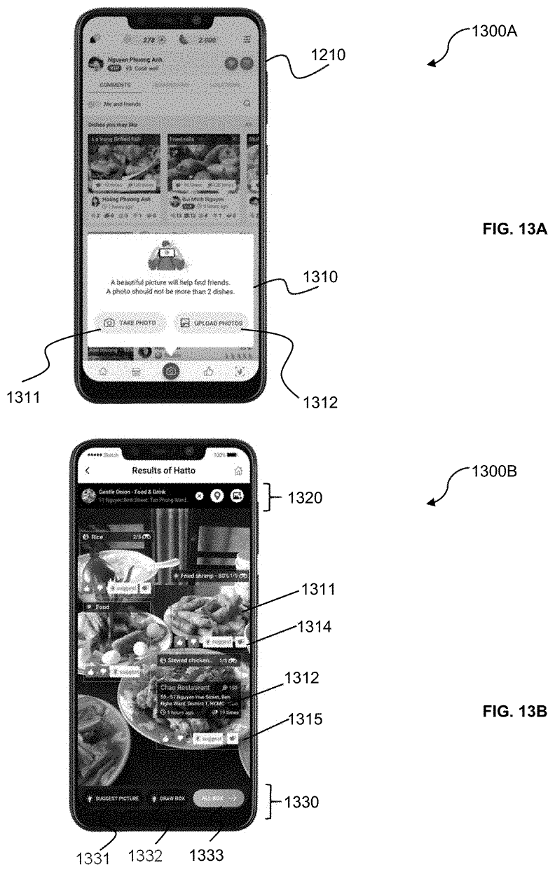

At step 302, the Hatto™ food socio-touristic media is opened by users. Step 302 is implemented by the hardware and software discussed in FIG. 5 and FIG. 11. More particularly, step 302 is implemented by a Hatto™ food socio-touristic web programs 542 written by WordPress software. The illustration of step 302 is shown in later FIG. 13A-FIG. 21C.

At step 303, an application in form of an icon or GUI is selected as shown in FIG. 12-FIG. 21. As a non-limiting implementation of step 303, a page includes a personal page that includes all personal information of a user, his/her status as a certified VIP chef or a babble user, his/her rewards as a result of gamification, her favorite food dishes, etc. Step 303 is implemented by the hardware and software discussed in FIG. 5 and FIG. 11. More particularly, step 303 is implemented by the execution of an interactive icon: a blogs, posts, and forums subroutine 542-1, a social network subroutine 542-3, a matching/displaying subroutine 542-4, a Hatto™ food tourism subroutine 542-5, and a Hatto™ gamification subroutine 542-6. When a user presses on an icon on his or personal page (see FIG. 13A), CPU and GPU cluster (or Hatto™ central brain) 541 executes the selected subroutine listed above. This way, each subroutine 541-1 to 541-6 has its own icon. Step 303 is illustrated as shown in later FIG. 12-FIG. 21. Please refer forward to FIG. 12B, examples of step 303 include icons such as a home icon 1251, a camera icon 1253, a thumb up icon 1254, and a gamification icon 1255.

At step 304, food input inquiries are posted in the socio-touristic media platform. Pages in the Hatto™ food socio-touristic media are interactive. As such, users can chat, send messages, post food input inquiries, rate his or her friends posts or comments, play games, etc. An illustration of step 304 is shown in FIG. 13A-FIG. 13B when a user takes a picture of his or her diner as a form of the food input inquiries.

At step 305, food input inquiries can be either text description in the forum page of the Hatto™ food socio-touristic media platform. Text description of a food input inquiry can be parsed using the Term-Frequency Inverse Document Frequency (TF-IDF) text mining algorithm as described in step 114. At this stage, step 305 is implemented by the TF-IDF algorithm to understand the description of the food input inquiries. More particularly, the TF-IDF text mining algorithm is implemented by fulltext queues database 1146, a Hatto™ fulltext parser 1156, and an elastic search 1166 in FIG. 11. In some aspects of the present invention, step 305 is included for the visually impaired users and certified chefs who may use Braille displays, so that the Hatto™ food socio-touristic media platform is inclusive to all users.

At step 306, food input inquiries can be images taken by the camera of the Hatto™ food socio-touristic media platform. In some aspects of the present invention, a user can use his/her cell phone to take a picture of the food dishes and post in the step 306 can only select only two input food images from each picture taken. In some other embodiments, the users may upload pictures of a food dishes that he or she has found in a magazine or other places. Step 306 is implemented as described in later FIG. 12-FIG. 21. More particularly, step 306 is implemented in FIG. 13A-FIG. 13B when a user takes a picture of the two dishes 1311 and 1312 in the Gentle Onion restaurant.

At step 307, food input inquiries can be a voice description entered into the Hatto™ food socio-touristic media platform. In some embodiments of the present invention, step 307 is included for the visually impaired users and certified chefs who may use a screen reader. A screen reader, as it implies, reads the screen using a speech synthesizer. If this is the case, a voice recognition and conversion step 309 begins. Speech synthesizers are well-known in the art and therefore will not be described in details in the present disclosure.

At step 308, food input inquiries are searched in the database using artificial intelligence (AI) lazy predictor described in FIG. 2 above. Step 308 can be implemented as shown in step 113 and FIG. 2 above. Step 308 is implemented by an AI lazy predictor engine 551 of a Hatto™ neural network 550. The illustrative implementations of step 311 will be discussed in FIG. 11-FIG. 21.

At step 311, determine if a match can be found. Step 311 can be implemented as shown in step 113 and FIG. 2 above. Step 311 is implemented by an AI lazy predictor engine 551 of a Hatto™ neural network 550. The illustrative implementations of step 311 will be discussed in FIG. 11-FIG. 21.

At step 312, if a match is found then display the results and related items in the Hatto™ food socio-touristic media platform. Step 311 is implemented by an AI lazy predictor engine 551 of Hatto™ neural network 550. The illustrative implementations of step 312 will be discussed in FIG. 11-FIG. 21. More particularly, the implementation of step 312 is illustrated in FIG. 13B when the names of the dishes and the addresses of the restaurants that offer the similar dishes are displayed. That is, Chao restaurant will offer the fried shrimp and stewed chicken dishes, the same as in the picture. Referring back to FIG. 2, the food images 1311 and 1312 are represented by square symbol 201. The dishes that have the shortest Euclidean distance from square symbol 201 (either fried shrimp or stewed chicken) are triangular points 202 and 203, which are fried shrimp and stewed chicken respectively. The related parameters are also found and represented by circular points 211-213, which are the same dishes and the Chao restaurant.

At step 313, if a match cannot be found, then post and find answers from the community of users and certified chefs in Hatto™ food socio-touristic media platform. The implementations of step 313 will be illustrated in FIG. 11-FIG. 21. Step 313 can be represented by polygon points 221-223 when the minimum Euclidean distances cannot be determined. At this point, the system of the present invention uses human intelligence from the Hatto™ food socio-touristic media to recognize the unknown dishes.

At step 314, determine whether the answers from the users in the social media are found. Then step 312 is repeated.

At step 315, where deep learning as described in step 140 in FIG. 1 begins. The food database is updated. Step 315 is implemented by steps 141-144 in FIG. 1 and by polygon points 220-223 in FIG. 2. Now, polygon points 221-223 and their characteristics are learned. The next time when the same dishes (i.e., 221-223) are searched, the artificial intelligence (AI) lazy predictor will find and post them as described in steps 311-312.

At step 316, gamification is started to provide incentives to the community of users. As alluded above, gamification step 316 can be rewarding as in subroutine C when users post proper food inquiries or answers. Otherwise, gamification step 316 can be punishing as in sub-routine D when the users post unrelated or illicit answers. The implementations of step 316 will be illustrated in FIG. 11-FIG. 21.

At step 317, determine whether new food input inquiries are received.

At step 318, if there are no other food input inquiries are received then software program 300 ends.

Otherwise, steps 304 to 317 are repeated.

Software program 300 achieves many objects of the present invention: (1) provides a supplemental means to artificial intelligence to identify foods that have many applications in medicine, dietary science, physiology, tourism, gastronomy, etc.; this is because no AI is better than human intelligence especially in the food recognition; creates a virtual place where AI is converged with human intelligence to provide a novel method of food recognition; (2) it provides a means for promoting tourism via foods; (3) it provides a means for improving the arts of cuisine.

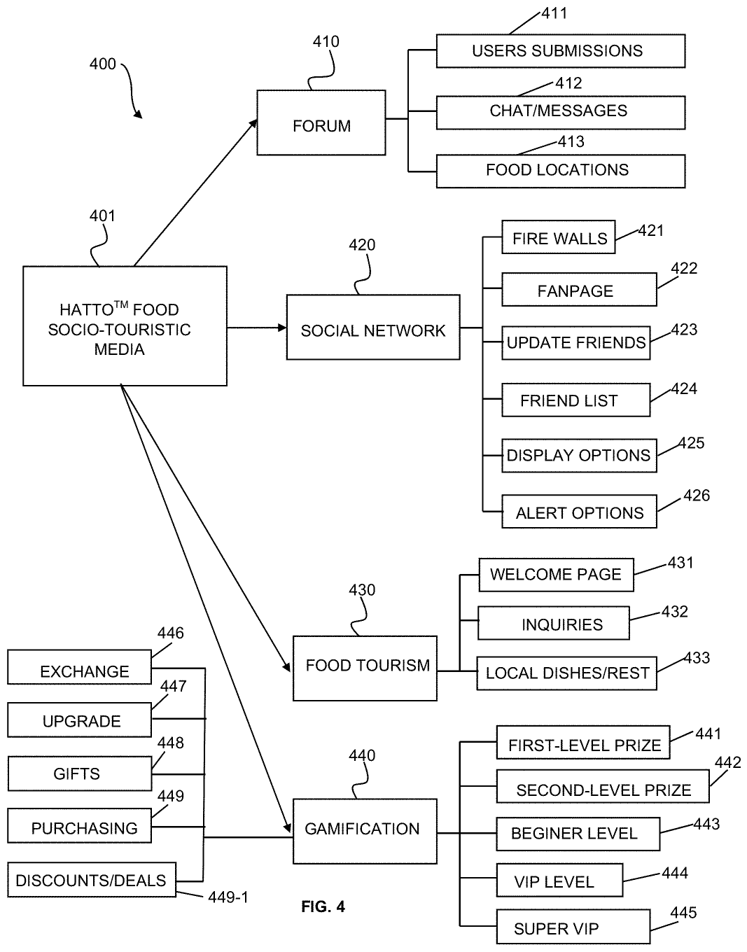

Next referring to FIG. 4, FIG. 4 is the organization of the Hatto™ food socio-touristic media in accordance with an exemplary embodiment of the present invention. A Hatto™ food socio-touristic media 401 includes a forum 410, a social network 420, a food tourism 430, and a gamification 440. In the present invention, Hatto™ 's food socio-touristic media 401 achieves many objects: (1) provides means to assist artificial intelligence (AI) in food recognition method that has applications in medicine, dietary science, physiology, tourism, gastronomy, etc.; this is because no AI is better than human intelligence especially in the food recognition; Hatto™ food socio-touristic media 401 is a virtual place where AI is converged with human intelligence to provide a novel method of food recognition; (2) provides means for promoting epicure traveling and tourism; (3) provides means for improving and promoting culinary arts; and (4) provides means for food analysis in sports and health physiology.

Forum 420 is a social media where the community of users and certified chefs can describe and post user submissions 411, exchange chats and messages 412, find food locations 413. Forum 420 also provides means for implementing step 114 in FIG. 1 and step 304 in FIG. 3. In some aspects of the present invention, when users are exchanging chats and messages, they can describe or attach pictures of food input inquires to their friends in forum 420. Hatto™ food socio-touristic media 401 can intercept these messages and provide answers to both primary users and secondary users.

Social network 420 can include firewalls 421, a fan-page 422, update friends 423, a friend list 424, display options 425, and alert options 426. Firewalls 421 can be both hardware and software which are implemented by firewalls 1112 in FIG. 11. Fan-page 422 includes advertising pages for business such as restaurants, hotels, retailers, certified super VIP chef to promote themselves on a personal page of a user. Fan-age 422 can be created on the profile page by calls-to-action to bring the users advertising to the forefront of Hatto™ food socio-touristic media 401. Similarly, friend list 424 can also be created and organized from the personal page of Hatto™ food socio-touristic media 401. In many aspects of the present invention, friend list 424 is also a smart friend list created by the analytics of the users' friend lists 424 in order to suggest new friends. In display options 425, the users can select how his or her Hatto™ food socio-touristic media 401 personal page is displayed or organized. Display options 425 are implemented by a matching and displaying subroutine 542-4 of Hatto™ socio-touristic platform web software programs 542 which will be discussed later in FIG. 5. Alert (notification) options 426 are part of the personal page. The users can choose what and how they are notified by selecting option button 1225 in FIG. 12B. Firewalls 421, a fan-page 422, update friends 423, a friend list 424, display options 425, and alert options 426 are integral parts of personal page 1200B of Hatto™ food socio-touristic media 401 which is written using WordPress program.

Food tourism 430 includes a welcome page 431, restaurant inquiries 432, and local dishes and restaurants 433. Welcome page 431 can be part of fan-page 422 designed to promote tourism. The GPS (Global Positioning System) of the communication devices of users and Hatto™ food socio-touristic media 401 always know the current location of the users. Alternatively, Hatto™ food socio-touristic media 401 learns of the users traveling plan via forum 410. In both cases, welcome page 431 appears on a personal page 1200B as the users arrive at a tourist destination. Restaurant inquiries 432 can be part of text food input inquires in step 305 or voice as in step 307. That is, the traveling user can ask in either text message (e.g., step 305), images (e.g., step 306), or voice command (e.g., step 307) the locations of the famous local restaurants. For example, when the user travels to Berkeley, Calif., she or he can turn on Hatto™ food socio-touristic media 401 and ask the location of the famous restaurant, “Chez Panisse”. Similarly, local dishes and restaurants 433 can be either text message (e.g., step 305), images (e.g., step 306), or voice command (e.g., step 307). Moreover, local dishes and restaurants 433 can be old images of food input inquiries 306 uploaded from the memory of the communication device of the traveling user.

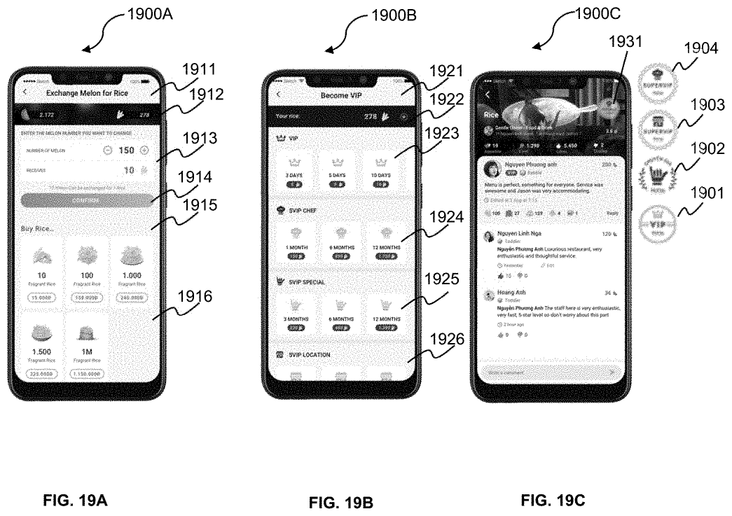

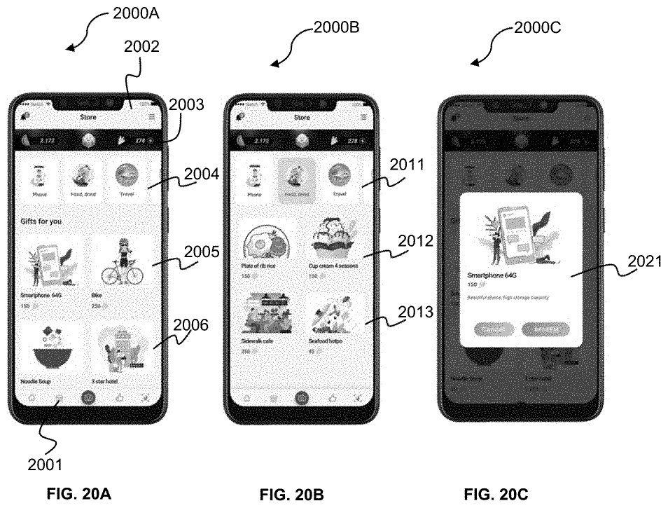

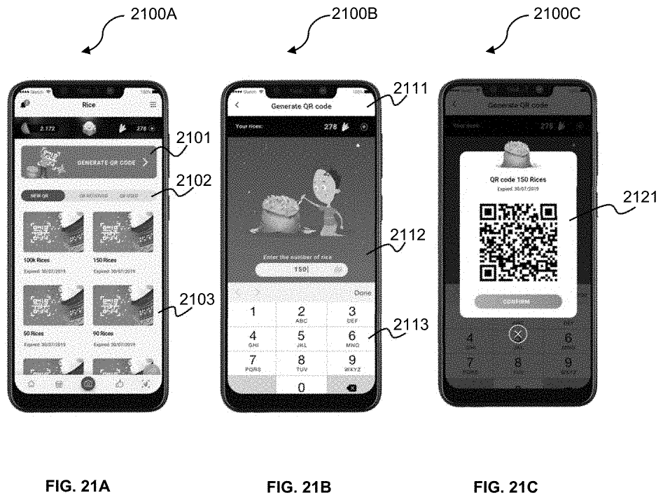

In the present invention, gamification 440 is designed to provide incentives to users to participate in the food recognition algorithm, to have funs, to form a network of friends, to enhance e-commerce for retailers and restauranteurs. Gamification 440 includes first-level prizes (watermelons) 441, second-level prizes (the Tam Rice) 442, a beginner level 443, a VIP level 444, super VIP levels 445, an exchange option 446, an upgrade option 447, gift option 448, purchasing option 449, and discount/deal options 449-1. First-level prizes 441 are the lowest reward given to the users when they either contribute positive posts and/or comments in Hatto™ food socio-touristic media 401. Alternatively, the users can receive first-level prizes 441 by receiving a certain amount of “thumb up” or positive reactions from other users. Second-level prizes (the Tam Rice) 442 are given to the users after they have earned more than a predetermined amount of first-level prizes 441. In many exemplary embodiments of Hatto™ food socio-touristic media 401, first-level prizes 441 are symbolized as watermelons, second level-prizes 442 are symbolized as the Tam Rice which is a prestigious type brand of rice grown in Vietnam. 50 watermelons can be exchanged for 1 Tam Rice. It is noted that watermelons, the Tam Rice are only non-limiting examples of first-level prizes 441 and second level prizes 442 respectively. Any other symbols can be used and within the scope of the present invention. Beginner level 443 is a level for users who first register to use Hatto™ food socio-touristic media 401 without any experience, prizes, and certification issued by the primary artificial intelligence (PAI). VIP level 444 is a next higher level to beginner level 443. Users at beginner level 443 can be promoted to VIP level 444 if they earn sufficient first-level prizes 441 and stay with Hatto™ food socio-touristic media 401 over a certain time. Higher than VIP level 444 is super VIP levels 445. Super VIP levels 445 further include a super VIP specialist, a super VIP restauranteur, and a super VIP chef. Please refer to super VIP levels 1902-1904 in FIG. 19 for illustrations. In many aspects of the present invention, an upgrade 447 allows beginner level 443 to become VIP level 444 to super VIP levels 445 by using second-level prizes 442. The upgrade needs to be approved by PAI. Next, a gift feature 448 gives beginner level 443, VIP level 444, and super VIP levels 445 gifts such as coupons, discounts, first-level prizes 441, and second-level prizes 442 to incentivize these members to participate in the food recognition process. In addition to gift feature 448, a purchasing feature 449 allows users to use their earned first-level prizes (watermelons) 441, second-level prizes (the Tam Rice) 442, gifts 448 to purchase products from retailers who are in alliance with Hatto™ food socio-touristic media 401. As a non-limiting illustrations, FIG. 20 and FIG. 21 show that members can buy smart phones by first generating a QR code using their earned prizes 441-442, gift 448, and/or paying with their own pocket money. Of course, if there is purchasing 449, a discounts and deals 449-1 must follow. Discounts and deals 449-1 include, but not limit to, discount coupons to restaurants, to movies; discount coupons to buy smart phones, cook books, or other products such as groceries, laptops, computers, and electronic products. Discounts and deals 449-1 may include an invitation to dine at no costs at popular restaurants.

Next referring to FIG. 5 which presents a hardware schematic diagram of a Hatto™ food socio-touristic network 500 in accordance with an exemplary embodiment of the present invention. Hatto™ food socio-touristic network 500 includes a computer network system 530, gateway interfaces and security firewalls 511, a network 510 which is configured to connect and serve a community of users 521-1 to 521-N, and a plurality of remote leaf databases 522-1 to 522-M via a first communication channel 561. Plurality of remote leaf databases 522-1 to 522-M are located outside and connected to computer network system 530 via network 510. It is noted that plurality of remote leaf databases 522-1 to 522-M can be data centers in different locations around the world and configured to provide important information to the food recognition process by the artificial intelligence and human intelligence of the present invention. It will be further noted that community of users 521-1 to 521-N includes beginner 443, VIP 444, and super VIPs 445. Beginner 443 has beginner symbol 1901. VIP 444 has symbol 1902. Super VIPs 445 have super VIP specialist symbol 1903, super VIP restauranteur symbol 1904, and super VIP chef 1905. All levels are included within the community of users 521-1 to 521-N.

Computer network system 530 includes an input/output (I/O) network interface 531, a master aggregator 532, a data center 533, a neural network 550, a Hatto™ central brain 540 (“central brain 540”). Master aggregator 532 combines and manages remote leaf data bases 522-1 to 522-M and data center 533. Central brain 540 further includes a cluster of central processing units and graphics processing units 541 (“cluster of CPU and GPU 521”) and a memory configured to store a Hatto™ socio touristic media web software programs 542 which launch Hatto™ food socio-touristic media 401 as described in FIG. 4. Hatto™ socio touristic media web software programs 542 includes the following subroutines: a blogs, posts, and forum subroutine 542-1, a member authentication subroutine 542-2, a social network subroutine 542-3, a matching and displaying subroutine 542-4, a Hatto™ food tourism subroutine 542-5, and a Hatto™ gamification 542-6. Functionally, blogs, posts, and forum subroutine 542-1 launches forum 410; member authentication subroutine 542-2 authenticates and verifies community of users 521-1 to 521-N when they log in; social network subroutine 542-3 launches social network section 520; matching and displaying subroutine 542-4 displays and notifies community of users 521-1 to 521-N when matches are found; Hatto™ food tourism subroutine 542-5 launches food tourism section 430; and a Hatto™ gamification 542-6 launches Hatto™ gamification 440. In many embodiments of the present invention, Hatto™ socio touristic media web software programs 542 and subroutines 542-1 to 542-6 are written using the WordPress program, Pythons, Java Script, PHP, C⁺⁺, C programming language so long as these programming languages are capable of constructing the functions as described.

Hatto™ neural network 550 is responsible for the artificial intelligence (AI) in the food recognition process while Hatto™ socio-touristic media 401 is responsible for the human intelligence and a medium to combine both intelligence. Hatto™ neural network 550 includes an artificial intelligence (AI) lazy predictor engine 551, a deep learning engine 552, an AI visionary and recommendation engine 553, and a search engine 554. Artificial intelligence (AI) lazy predictor engine 551 operates as described in FIG. 1 and FIG. 2. Deep learning engine 552 implements deep learning algorithm 140 in order to (1) learn new food dishes and related parameters, (2) store new dishes and their features, and (3) learn to recognize new dishes next times these same food dishes are posted. That is, polygonal points 221-223 are learned and updated into Hato™ data center 553. Consequentially, data center 533 stores more and more new dishes and AI lazy predictor 551 becomes smarter, capable of recognizing more and more dishes. In various embodiments of the present invention, remote leaf databases 522-1 to 522-M located around the world can be connected to Hatto™ data center 533, AI lazy predictor engine 551, and deep learning engine 552 so that international food dishes can be recognized. In addition, this allows international users as part of the community of users 521-1 to 521-N can participate and have funs in Hatto™ socio-touristic media 401. AI visionary & recommendation engine 553 performs analytics on users 521-1 to 521-N behavioral patterns in order to send out appropriate advertisements, rewards, friend suggestions, foods and restaurants recommendations. Search engine 554 includes text search which can be either pure texts or texts converted from voice commands. In various embodiments of the present invention, AI lazy predictor engine 551 includes a queues database, a firewall, and a graphic processing unit (GPU).

Continuing with FIG. 5 in reference with FIG. 1 to FIG. 4, in operation, at the beginning at step 111 in FIG. 1, cluster of central processing units and graphic processing units 532 executes software program 300 to launch Hatto™ socio-touristic media 401. As a user 521-1 logs in, his or her device is connected to computer network system 530 via network 510 via I/O network interface 531. Gateway interfaces and security firewalls 511 determines that whether this user is either blocked or has been registered. In addition, firewalls 421 and security firewalls 511 determines whether this user is blocked and/or the messages are valid. VIP and members authentication program 542-2 is also executed to check the status of user 521-1. If user 521-1 is not blocked and having a good standing status, cluster of central processing units and graphic processing unit (CPU and GPU) 541 executes Hatto™ socio-touristic media software programs 540. After that, his or her personal page will be displayed by cluster central processing units and graphic processing units 541. The personal pages of user 521-1 includes forum 410, social network 420, food tourism 430, and gamification 440 as described in FIG. 4. 327 known food dishes, their 1,792 features, and related parameters are stored in Hatto™ data center 533. Food input inquiries step 114 is implemented by blogs, posts, and forums module 542-1. Artificial intelligence lazy predictor searching routine 120 is implemented by neural network 550 which includes artificial intelligence lazy predictor engine 551 as described in step 113 and FIG. 2. Deep learning engine 552 implements deep learning algorithm 140 of FIG. 1. Blogs, posts, and forums module 542-1 implements step 114 of FIG. 1. Hatto™ gamification module 542-6 implements rewarding gamification C 151 and penalty gamification D 152. Matching and displaying program 542-4 implements step 123 in FIG. 1. Hatto™ food tourism software module 542-5 implements food tourism 430 and steps 114, 121 and 122.

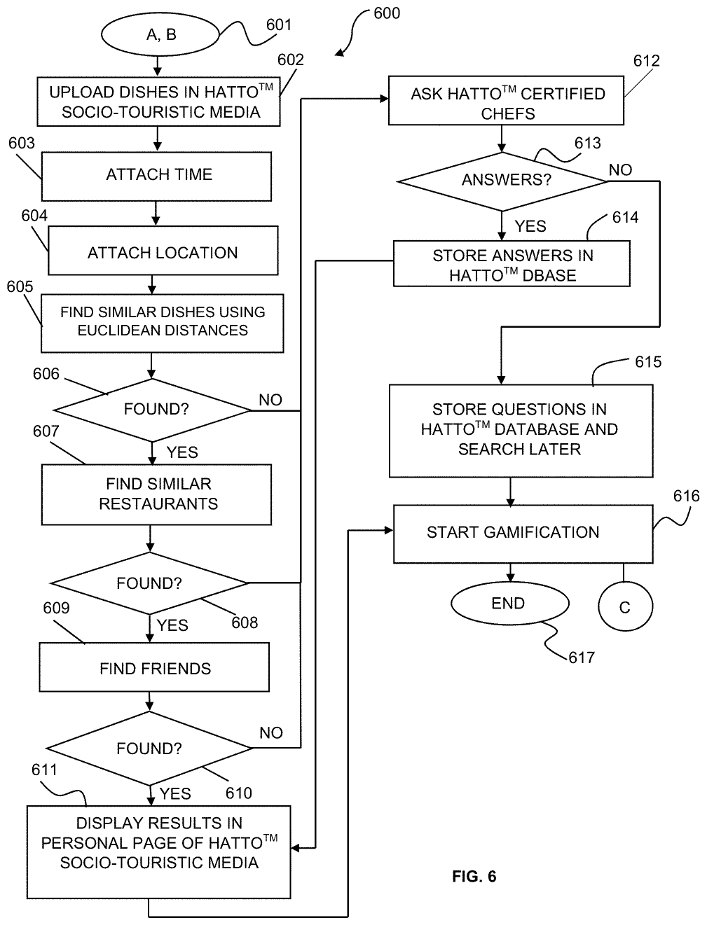

FIG. 6 is a flow chart of the input and search algorithm 600 in the Hatto™ food socio-touristic media software program that utilizes the food recognition method described in FIG. 1 and FIG. 2 in accordance with an exemplary embodiment of the present invention in accordance with an exemplary embodiment of the present invention is illustrated.

At step 601, algorithm 600 begins at A and B. A and B represent two different methods of entering the food input inquiries. A represents the food input inquires posted by primary users, 521-1 to 521-N, in forum 410. B represents the food input inquires posted by secondary users (also among 521-1 to 521-N) who are friends viewing the primary users personal page. Algorithm A and B handle both methods of food input inquires the same way. Step 601 is implemented by loading Hatto™ food socio-touristic media 401 which is rendered by the execution of Hatto™ socio-touristic media web software programs 542 by cluster of central processing unit (CPU) and graphic processing unit (GPU) 541. In addition, VIP and members are also authenticated to allow only members with good standing status to use Hatto™ food socio-touristic media 401. This authentication substep is implemented by member authentication subroutine 542-2.

At step 602, food input inquiries are posted in Hatto™ food socio-touristic media. Step 602 is implemented by blogs, posts, and forums subroutine 542-1. As alluded in FIG. 3, food input inquiries can be in form of photo images, speech, and text messages in forum 410.

At step 603, date and time of the food input inquiries are attached to post. Step 603 is implemented by features in photo images, speech, and text messages in forum 410 and communication devices of users 521-1 to 521-N that can attach the current date and time when food input inquiries are posted. Communication devices of users 521-1 to 521-N include cellular phones, computers, laptops, tablets, etc.

At step 604, the location of the user who posts the food input inquiries is attached. Step 604 is implemented by features in photo images, speech, and text messages in forum 410 and the communication devices that can attach the Global Positioning System (GPS) location (address) of a post.

At step 605, food input inquiries and similar parameters are located by artificial intelligence lazy predictor. Step 605 is implemented by artificial intelligence lazy predictor search step 121 in FIG. 1 and AI lazy predictor engine 551. Food input inquiries are illustrated by square symbol 201 in FIG. 2.

At step 606, determine if similar food dishes are found. After the search by artificial intelligence lazy predictor search step 121, cluster of CPU and GPU 541 and AI lazy predictor engine 551 also determines if similar food dishes of the food input inquiries are found. Similar food dishes are one of the related parameters illustrated by step 113 and food dishes 210 in FIG. 2.

At step 607, similar restaurants are located by artificial intelligence lazy predictor. As alluded before, similar restaurants are one of the related parameters kept in record by AI lazy predictor engine 551 in concert with cluster of CPU and GPU 541.

At step 608, whether similar restaurants that offer similar food dishes are determined. Cluster of PU and GPU 532 also determines if similar food dishes to food input inquiries are found. Similar restaurants are one of the related parameters illustrated by step 113 and food dishes 210 in FIG. 2

At step 609, friends among the community of users that like the same food input inquiries are searched by artificial intelligence lazy predictor. As alluded before, friends who like the same or similar food dishes are one of the related parameters kept in record by AI lazy predictor engine 551 in concert with cluster of CPU and GPU 541.

At step 610, determine if friends who like similar food dishes are found. Cluster of PU and GPU 541 also determines if similar food dishes to food input inquiries are found. Friends who like the same or similar food dishes are one of the related parameters illustrated by step 113 and food dishes 210 in FIG. 2

At step 611 display all results from steps 602-609. Step 611 is implemented by matching and displaying module 542 in connection to a display device of user 521-1.

At step 612, if no results are found, then ask certified chefs or community of users. In case neural network 550 and AI lazy predictor engine 551 cannot locate the answers, the unanswered food input inquiries are posted in Hatto™ food socio-touristic media 540 to solicit answers from the community users and certified chefs, 521-1 to 521-N.

At step 613, determine if answers to step 612 are found. Step 613 is implemented by inquiries and recommendations module 541 as part of Hatto™ socio-touristic media web software programs 542.

At step 614, if answers are found then store in the database and start the deep learning process as described above. Step 614 is implemented by deep learning engine 552. The answers are analyzed by breaking down the answers from the users into features as described in step 113 and used to teach AI lazy predictor engine 551.

At step 615, if no answers are found, then store the food input inquiries for future analysis. Step 615 is handled by cluster of CPU and GPU 541 which stores the unrecognized food input inquiries to Hatto™ data center 533 for future analysis by Hatto™'s group of certified chefs or by the community of users. In many aspects of the present invention, this situation identified by step 615 is very rare because the food input inquiries must be very rare dishes that neither artificial intelligence nor human intelligence can identify.

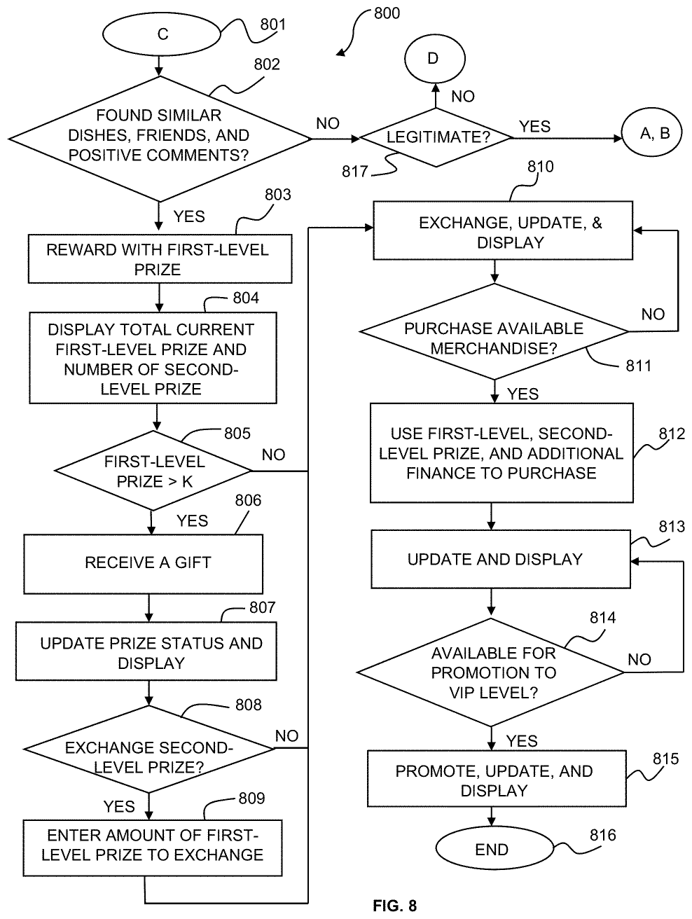

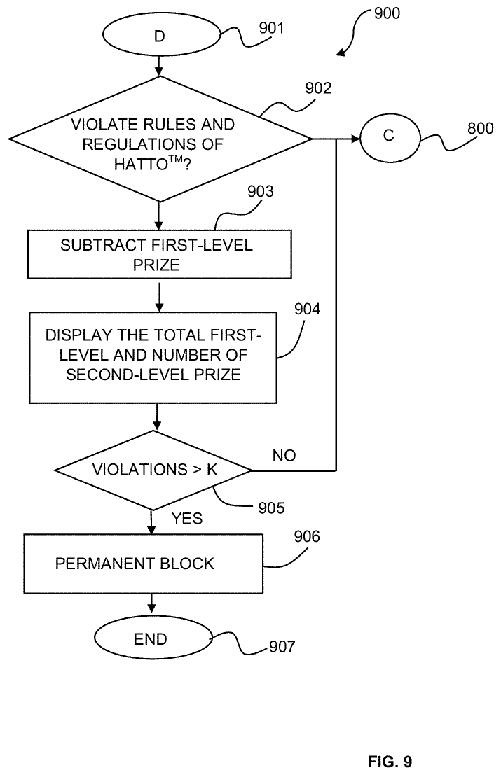

At step 616, the gamification starts to incentivize users to participate in the food recognition process. Step 616 is implemented by Hatto™ gamification software module 542-6. Positive gamification program C 151 as well as negative (punitive) gamification program D 152 starts. The details of the gamification program C 151 and negative (punitive) gamification program D 152 will be described in FIG. 8-FIG. 9 and illustrated in FIG. 19-FIG. 21.

At step 617, algorithm 600 ends. As the results of step 617, new dishes, new friends, and new restaurants are found and stored in Hatto™ data center 533. In other situations, the overall status of each user is also updated in the user personal page in Hatto™ food socio-touristic media 401.

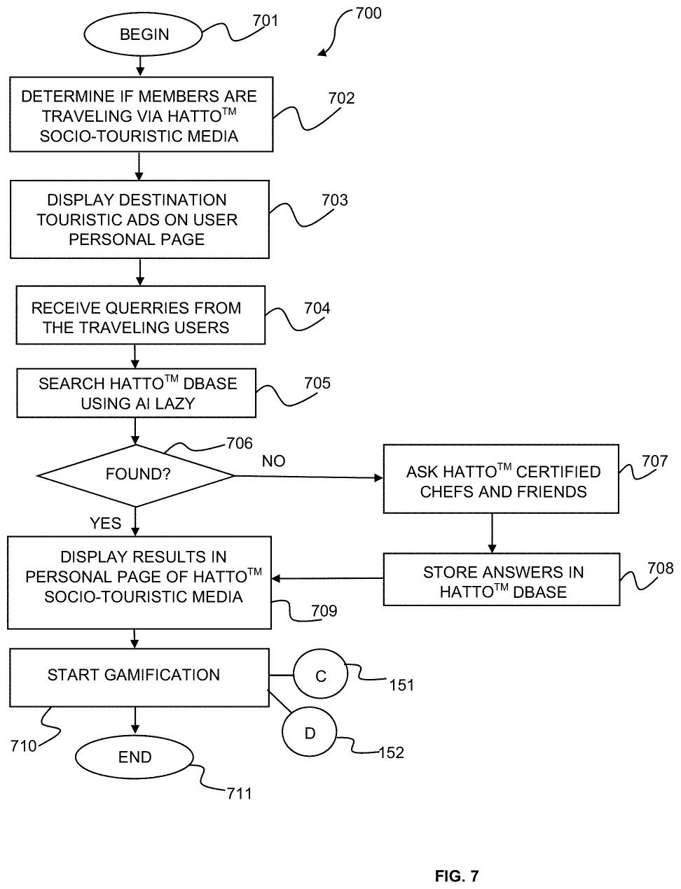

FIG. 7 is a flow chart of the food touristic algorithm 700 in the Hatto™ food socio-touristic media software program that utilizes the food recognition method described in FIG. 1 and FIG. 6 in accordance with an exemplary embodiment of the present invention.

Food touristic algorithm 700 implements methods 100, 200, 300, and system 400 that combines artificial intelligence lazy predictor and human intelligence in a food socio-touristic media to synergistically enhance the ability to recognize a wide variety of food dishes.

At step 701, food touristic algorithm 700 begins. In many aspects of the present invention, step 701 begins when (1) Hatto™ food socio-touristic media 410 opens and the personal front page of the user is loaded, or (2) deep learning engine 552 recognizes the habit of that user.

At step 702, whether users, 521-1 to 521-N, are traveling are determined. As mentioned in step 701, when Hatto™ food socio-touristic media 410 learns or receives posts that a user, e.g. user 521-1, is traveling, food touristic algorithm 700 starts.

At step 703, displaying touristic ads on the personal page of the traveling users. The GPS module (not shown) in the communication device of a user, e.g. user 521-1, in cooperation with cluster of CPU and GPU 541 recognize the location of user 521-1 and posts according traveling ads including taxi, Grab™, Uber™, hotels, grocery stores, entertainments, touristic sites, and nearest restaurants that offer food dishes that user 521-1 habitually has had. Step 703, in many aspects, is implemented by neural network 550 and deep learning engine 542. If user 521-1 finds any useful ads, he or she can touch to select the destination that the ads are offering.

At step 704, food input inquiries from the traveling users are posted. In case when user 521-1 cannot find any useful ads, he or she may post food input inquiries on Hatto™ food socio-touristic media 410. Step 704 is implemented by blogs, posts, and forums subroutine 542-1.

At step 705, the food input inquiries are searched in databases. In the present disclosure, the food input inquiries are search in the Hatto™ data center 533 and remote leaf databases 522-1 to 522-M by artificial intelligence lazy predictor engine 551 as described in step 113 in FIG. 1 and step 308 in FIG. 3 above. The implementation of step 705 is also illustrated by the search for square symbol 201 in FIG. 2 using AI lazy predictor engine 551 and search engine 554.

At step 706, whether the food input inquiries are found is determined. Cluster of CPU and GPU 541 in connection with neural network 550 determine whether food input inquiries represented by square symbol 201 are found.

At step 707, if no answers are provided, then certified chefs and the community of users, e.g., 521-1 to 521-N, in the Hatto™ food socio-touristic media. If the closest answers represented by triangular symbols 202-203 and related parameters 211-213 are not found, the food input inquiries are sent forward by inquiries and recommendations module 541 so that the intelligence of the certified chefs and community of users can provide the answers to user 521-1. The answers are represented by circular symbols 221-223 in FIG. 2.

At step 708, the answers are stored in the database and deep learning procedure begins. Step 708 is implemented by Hatto™ data center 533 and deep learning algorithm 140 and deep learning engine 552.

At step 709, if answers are found by the artificial intelligence lazy predictor, then results are displayed on the personal page of the traveling users. Step 709 is implemented by matching/displaying module 542-4. More particularly, square symbol 201 and related parameters triangular symbols 202, 203, and circular symbols 211-213 are displayed on the personal page of a user, e.g., user 521-1.

At step 710, gamification is started to provide incentives to the community of users. Step 710 is implemented by Hatto™ gamification software subroutine 542-6. Positive gamification program C 151 as well as negative (punitive) gamification program D 152 start

At step 711, algorithm 700 ends. As the results of step 711, new dishes, new friends, and new restaurants are found and stored in Hatto™ data center 533. In other situations, the overall status of each user is also updated in that user personal page in Hatto™ food socio-touristic media 401.

Referring to FIG. 8, a flow chart of an incentivized gamification 800 in the Hatto™ food socio-touristic media software program supplementing the food recognition method described in FIG. 1 and FIG. 2 in accordance with an exemplary embodiment of the present invention is illustrated.

At step 801, the rewarding (or positive) gamification is started and identified as gamification C.

At step 802, food input inquiries and similar parameters include friends who like the same foods, restaurants that offer the same dishes, positive comments, and recipes are determined. Referring back to FIG. 2, step 802 searches for square symbol 201, triangular symbols 202-203, and circular symbols 211-213. This is implemented by artificial intelligence lazy predictor 551 and Hatto™ food socio-touristic media software program 540. As described above, square symbol 201, triangular symbols 202-203, and circular symbols 211-213 are first searched using artificial intelligence lazy predictor 551. If the results are not found, human intelligence is used by posting food input inquiries and similar parameters into Hatto™ food socio-touristic media 410. The community of users and certified chefs, 521-1 to 521-N, are enabled to identify the food input inquiries and recommend similar parameters. This is made possible by Hatto™ gamification subroutine 542-6.

At step 803, if food input inquiries and similar parameters are found, then users who post such inquiries and receive a certain number of “likes”, “hearts or loves”, positive reactions, or discussions from other members are rewarded with a first-level prize, e.g., watermelons. In many aspects of the present invention, the first-level prize is symbolized as a watermelon. Please refer to 1222 in FIG. 12B as an illustration of step 803.

At step 804, the total number of first-level prizes symbolized by watermelons earned by a user is displayed on the personal page. Step 804 is implemented by gamification section 440 and first-level prize 441 in FIG. 4, which are created by Hatto™ gamification subroutine 542-6 that sums up the total number of first-level prizes user, e.g. 521-1, has earned and displays it on the personal page of user 521-1. Please refer to 1222 in FIG. 12B as an illustration of step 804.

At step 805, whether the total first-level prizes which are greater than a positive threshold number K are determined. Gamification section 440 determines whether the current total number of first-level prizes is greater than a preset threshold number. In some embodiments of the present invention, this threshold number K is set to 200. That is, if the number of first-level prizes exceeds 200, a user, e.g., 521-1, is entitled to have either (1) exchange option 446, (2) upgrade option 447, (3) gifts 448, (4) purchasing 449, and (5) discounts and deals 449-1. Step 804 is implemented by Hatto™ gamification subroutine 542-6 which is listed as gamification section 440.

At step 806, users are given a gift if the total number of first-level prizes (watermelons) earned exceeds a threshold number K. As discussed in FIG. 4, a gift can include a discount card for a purchase, for favorite dishes at the favorite restaurant, a promotion, a job opportunity, etc. The gift can also be a deal, a number of first-level prizes (e.g., watermelons) or second-level prizes (the Tam prizes).

At step 807, the total number of first-level prizes and gifts are displayed. As a result of step 806, the current total number of first-level, second-level prizes, and gifts earned by is updated on the personal page of a user, e.g., 521-1. Please see 1221 and 1222 in FIG. 12B as illustrations of step 807.

At step 808, whether users want to exchange first-level prizes (watermelons) to a higher prizes (e.g., the Tam Rice) is determined. Step 808 is implemented by the action of a user; e.g., 521-1, including pressing the exchange option 446, upgrade option 447, purchase option 449. Step 808 is implemented by Hatto™ gamification subroutine 542-6 and illustrated by exchange action 1916 in FIG. 19A-FIG. 19C.

At step 809, if the answer is yes, then the users are asked to enter the total amount of first-level prizes (watermelons) they want to exchange.

At step 810, perform the exchange and display the end results.

At step 811, determine if the users want to use first-level prizes (watermelons) and Tam rice to purchase discounted merchandises. Step 811 is implemented by purchasing option 448 in gamification section 440 and Hatto™ gamification subroutine 542-6.

At step 812, if the answer is yes, then the purchase is performed. Users may use all of his or her prizes including first-level prizes (watermelons) or the second-level prizes (the Tam Rice) to purchase of products. Alternatively, users may use available discount cards, deals, and personal finance to complete the purchase. It is noted that, users may use these available means to go to a diner with his or her friends at his or her favorite restaurants. Step 812 is implemented by purchasing option 448 in gamification section 440. For example, a user, e.g., 521-1, may use all or part of his 8,000 first-level prizes he has earned to pay for diner with his girlfriend at his favorite restaurant. He can also use all or parts of his 8,000 watermelons to buy an IPhone X. Alternatively, he can use additional second-level prizes (the Tam Rice) to make this purchase plus his own money via a credit card in case his first-level prizes (watermelons) are not sufficient. Step 812 is implemented by Hatto™ gamification subroutine 542-6 and illustrated by QR code 2101 in FIG. 21A-FIG. 21C.

At step 813, the prizes status are updated and displayed on the personal page of the users, e.g., 521-1 to 521-N. After the purchase in step 812, the remainder prizes (first-level prizes and second-level prizes) are updated and displayed on the user personal page. Please see display 2003 in FIG. 20A-FIG. 20C as illustrations of step 813.

At step 814, that the users are available to a promotion is determined. In many aspects of the present invention, a user is available to a promotion if that user has been a loyal member of Hatto™ socio-touristic media 401 over a certain amount of time, i.e., 2 years, and with a good standing. In addition, in some other embodiments of the present invention, Hatto™ socio-touristic media 401 may also require that a user must have earned a significant amount of first-level prizes and second-level prizes to be available for a promotion. Please see a promotion display 1921 in FIG. 19B as an illustration to step 814.

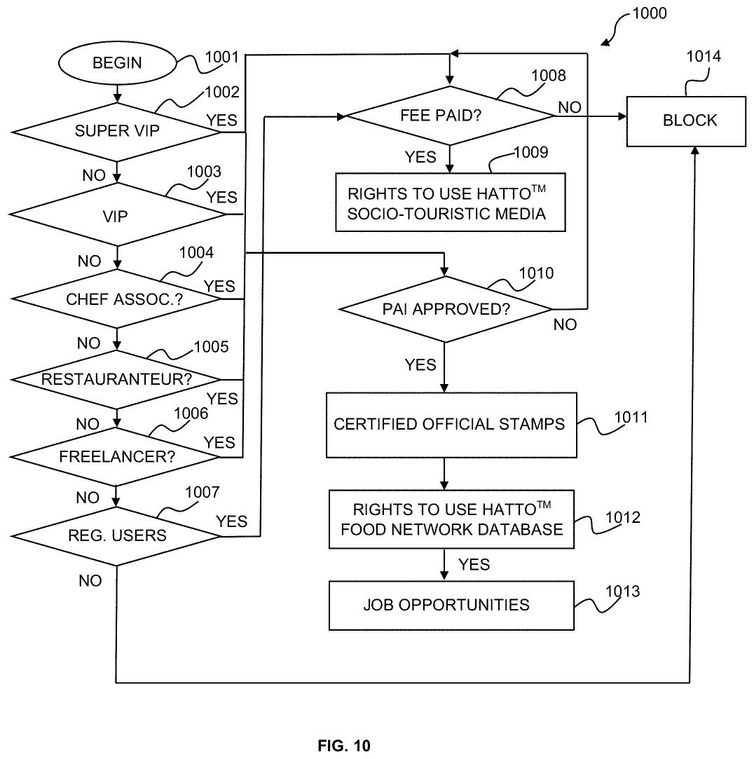

At step 815, if the promotion is guaranteed, then the users are promoted and their statuses are updated accordingly. If the promotion conditions cited in step 814 are satisfied, that user is promoted to a VIP level 443 or a super VIP level 444. The perks and privileges of VIP level or super VIP level will be described in FIG. 10.

At step 817, if similar dishes, friends who like same dishes, and positive comments and reactions are not found by both means, i.e., artificial intelligence and human intelligence of users, 521-1 to 521-N, in Hatto™ socio-touristic media 401, then the legitimacy of the posts is determined. In the present disclosure, legitimacy includes whether the posts contain illicit contents and/or political comments. If the post is deemed illegitimate, users can enter another posts by means of algorithm 600 indicated as A and B in FIG. 6. Otherwise, when the posts are not legitimate, punishing or punitive gamification D begins as described in the following FIG. 10. Step 817 is implemented by a fulltext queues database 1146, an elastic search 1166, and a fulltext parser 1156 in FIG. 11.

Next referring to FIG. 9, a flow chart of the penalty gamification D 900 in the Hatto™ food socio-touristic media software program that utilizes the food recognition method described in FIG. 1 and FIG. 2 in accordance with an exemplary embodiment of the present invention is illustrated.

At step 901, the penalty gamification is started and identified as gamification D.

At step 902, whether input inquiries, comments, and actions of users violate Hatto™ rules and regulations are determined. Step 902 is implemented by the Term-Frequency Inverse Document Frequency (TF-IDF) text mining algorithm as described in step 114. As an illustrating example, if the food input inquiries contain illicit content and political comments that have nothing to do with foods, both the TF-IDF of artificial intelligence system and the socio-media will reject, block, and conclude that the posting users have violated the rules and regulations of Hatto™. More specifically, step 902 is implemented by a fulltext queues database 1146, an elastic search 1166, and a fulltext parser 1156 in FIG. 11. Elastic search 1166 and fulltext search 1166 use Term-Frequency Inverse Document Frequency (TF-IDF) text mining algorithm as described in step 114.

At step 903, if the answer is yes, then the first-level prizes (watermelons) are subtracted from such users. Step 903 is implemented by Hatto™ gamification subroutine 542-6.

At step 904, the remaining first-level prizes (watermelons) are updated and displayed. Step 904 is implemented by Hatto™ gamification subroutine 542-6.

At step 905, whether the total violations are greater than a preset threshold number. Step 905 is implemented by Hatto™ gamification subroutine 542-6.

At step 906, if the number of violations is greater than the preset threshold number, the users, e.g., 521-1 to 521-N, are blocked permanently. Security firewalls 511 block these users from this moment on.

At step 907, if the answer is no then start gamification algorithm 800 identified as C above if the posts are determined to be valid and received positive, like comments, or good reactions from the community of users, e.g., 521-1 to 521-N.

Referring next to FIG. 10, a flow chart of the status algorithm 1000 in the Hatto™ food socio-touristic media software program utilizing the food recognition method described in FIG. 1 and FIG. 2 in accordance with an exemplary embodiment of the present invention is illustrated.

At step 1001, algorithm 1000 begins when users start to log in Hatto™ food socio-touristic media 401. Hatto™ food socio-touristic media 401 first checks the status when a user, e.g., 521-1 to 521-N, logs in. The list of users and their up-to-date standing are stored in Hatto™ data center 533.

At step 1002, determine if a user is a super VIP which is the highest level. In many embodiments of the present invention, super VIP further divides into a super VIP specialist 1902, a super VIP restauranteur 1903, and a super VIP chef 1904 as illustrated in FIG. 19C. In FIG. 19C, the user Nguyen Phuong Anh (one of the users 521-1 to 521-N) is a VIP member with a VIP title attached to her personal page and the Gentle Onion Food and Drink restaurant is a super VIP chef 1904 with the appropriate symbol 1931 attached to the restaurant picture.

At step 1003, if the user is not a super VIP, then determine if user is a VIP member which is the second highest ranking. Referring again to FIG. 19C, the user Nguyen Phuong Anh (one of the users 521-1 to 521-N) is a VIP member with a VIP title attached to her personal page.

At step 1004, if the log-in user is not a VIP member, then determine if the user belongs to a chef association recognized by the primary artificial intelligence (PAI).

At step 1005, if the user does not belong to the recognized chef association, then determine if the user is an independent restauranteur. In many aspects of the present invention, if users own and operate restaurants that are mentioned and recommended in Hatto™ food socio-touristic media 401, then these users are classified as restauranteurs. The knowledge and contributions of these restauranteurs, supplementary to the artificial intelligence, are very valuable since no artificial intelligence is better than human intelligence. This is especially true when the recognition of foods is needed. Yet, this is even truer when the human intelligence is an expert in foods such as restauranteurs, food critics, epicure, or chefs.

At step 1006, if the log-in user is not a restauranteur, then determine if the user is a freelancer which is either a food critic for a magazine or newspapers, or an epicure.

At step 1007, if none of the above are true, then determine if the log-in user is a registered user. In some aspects of the present invention, registered users may need to pay a fee. In other aspects of the present invention, only VIP members and super VIP members need to pay a fees in order to receive benefits and perks from Hatto™ food socio-touristic media 401. It will be noted that, whether registered users, e.g., 521-1 to 521-N, pay a fee to join Hatto™ food socio-touristic media 401 are within the scope of the present invention.

At step 1008, if all of the above are true, then determine if these users are current in annual fee payments. Again, the list of registered users, super VIP, VIP, association of chefs, restauranteurs, freelancers and their ranking are maintained by Hatto™ data center 533 and managed by cluster of CPU and GPU 541 and neural network 550.

At step 1009, if these users are current in annual fee payments and/or not blocked by violations of the Hatto™ rules and regulations more than the preset amount of times K, then allows them to use Hatto™ food socio-touristic media 401.

At step 1010, if the log-in users are super VIP, VIP, chefs in a recognized chef association, restauranteurs, freelancers, then determined if they are approved by the principal artificial intelligence (PAI). Step 1010 is implemented by neural network 550 in conjunction with cluster of CPU and GPU 541.

At step 1011, if the log-in users are approved by the PAI then they are stamped with a certified official stamp on the personal page. A sample of the certified official stamp will be illustrated later in FIG. 12-FIG. 21. More particularly, the user Nguyen Phuong Anh (one of the users 521-1 to 521-N) is a VIP member with a VIP title attached to her personal page and the Gentle Onion Food and Drink restaurant is a super VIP chef 1904 with the appropriate symbol 1931 attached to the restaurant picture.

Step 1012-1013 describe the perks and privileges of having the certified official stamp from Hatto™ food socio-touristic media 401.

At step 1012, users with certified official stamp are given the rights to modify the food database. In some aspects of the present invention, users with certified official stamp can provide answers to the unanswered food input inquiries and their answers are used to teach artificial intelligence lazy predictor engine 551 and deep learning engine 552. In other aspects of the present invention, users with certified official stamp can provide images, written articles, any information that help deep learning engine 552 to learn and analyze new food input inquiries illustrated by circular symbols 220 in FIG. 2. Yet in other aspects of the present invention, users with certified official stamp are given the rights to log in and directly enter information which helps deep learning engine 552 to learn and analyze new food input inquiries.

At step 1013, users with certified official stamps are also provided with job opportunities with restaurants that register with Hatto™ food socio-touristic media. More specifically, Hatto™ food socio-touristic media 401 can connect users having certified official stamsp with registered member restauranteurs for their mutual benefits: users can have a job at a good restaurant. In return, the restaurant has a good chefs since users with certified official stamp are proven via Hatto™ food socio-touristic media 401 to have good knowledge and personality to be a dependable chef.

Finally, at step 1014, if any of the above users does not pay annual fees and/or blocked by violations of the Hatto™ rules and regulations more than the preset amount of times K, they may be blocked from using Hatto™ food socio-touristic media 401.

From the foregoing disclosure, Hatto™ food socio-touristic media 401 and method 1000 do not only provide means to combine artificial intelligence and human intelligence in the food recognition process but also a platform to make friends, to learn, to entertain, to travel, to have funs, to network, and to find job opportunities. Method 1000 is implemented by the hardware system 500 and system 1100 as described next in FIG. 11.

Referring now to FIG. 11, a comprehensive hardware and software system architecture 1100 of the Hatto™ food socio-touristic media “system 1100” in accordance with an embodiment of the present invention is illustrated. System 1100 illustrates a more detailed hardware and software description of FIG. 5. In operation, system 1100 are as described that is used to execute all algorithms 100-1000 above.

System 1100 includes users (e.g., 521-1 to 521-N) communication devices 1110, a cloud flare 1111, a webserver 1120, and a neural network 1150. Communication devices 1110 can be a smart phone, a desktop computer, a tablet, or a laptop. Cloudflare 1111 provides web services and security that include Web application firewall (WAF), caching purge providing latest content to users, routing, load balancing, Distributed Denial of Service (DDoS) mitigation, WAN optimization, etc. After cloudflare 1111, firewall 1112 is used to block malicious and/or illicit contents from being posted in Hatto™ socio-touristic media 401. Apache 2 WSGI 1121 is a web service gateway interface used to host different web applications described in FIG. 12-FIG. 21. Examples of the web applications include personal page, posts, gamification, reward statuses, etc. In various embodiments of the present invention, Hatto™ socio-touristic media 401 is constructed using Wordpress software application 1123. MySQL application 1123 is used to manage MySQL Cluster 1128 which is Hatto™ data center 533. In fact, Hatto™ data center 533 is a cluster of network databases which are connected to each other via network 510. The communication between client device 1110 and network 510 is serviced by cloudflare 1111.

Continuing with FIG. 11, since Hatto™ data center 533 is accessed by many users (i.e., 521-1 to 521-N) at the same time, it is partitioned into different nodes which are served by SQL nodes 1131. Each node can access to data node 1135-1 to 1135-K in a network database storage engine 1135. User node or SQL node 1132 is connected to network database (NDB) storage engine 1135 by a NDB API (application program interface) 1131. On the other hand, manager node MGM node 1133 are connected to NDB storage engine 1135 by a NDB API (application program interface) 1134. This architecture of network database (NDB) also manages leaf remote databases 522-1 to 522-M. Similarly, a load balancer 1124, connected and controlled by firewall 1112, to manage the load of users who want to access Hatto™ food socio-touristic media 401. In order to achieve this goal efficiently, system 1100 partitions web servers 1125 for Hatto™ food socio-touristic media 401 into a web server group 1, web server group 2, etc. which are connected and controlled by firewalls 1112 and managed by MySQL Cluster 1128. Load balancer 1124 regulates to achieve efficiency in distributing users to Hatto™ food socio-touristic media 401. Referring back to FIG. 4, in various embodiments of the present invention, web server 1125 is partitioned into web server forum 410, web server social network 420 for social network including forums; groups such as chat, friend lists, fan page; webserver food tourism 430; and web server gamification 440. The queues into web server 1125 is managed by load balancer 1124 and their contents are controlled by firewalls 1112.

Continuing with FIG. 11, a neural network 1180 includes a Redis open source in-memory data structure store 1157, an AI visionary queue database 1141, a AI lazy predictor queue database 1142, an AI lazy predictor queue database 1143, an AI lazy recommender and ADS queue 1144, an APN queues database 1145, a full text queue 1146. Via firewall 1112, AI visionary queue database 1141 is connected to an AI vision-farm server 1151 which is, in turn, connected to a first Nvidia graphic processing unit (GPU) 1161. Via firewall 1112, AI lazy predictor queue database is connected to an AI lazy predictor 1152 which is, in turn, connected to a second Nvidia GPU 1162. Via firewall 1112, AI lazy validator queue database 1143 is connected to a lazy validator queue database 1153 which is, in turn, connected to a third Nvidia GPU 1163. Via firewall 1112, AI lazy recommender & ADS queue database 1144 is connected to an AI RecSys & ADS server 1154 which is, in turn, connected to a recommendation system (RS) 1164. Via firewall 1112, AI queue database 1145 is connected to PA service 1155 which is, in turn, connected to an Apple Push Notification Service (APNS) 1165. Via firewall 1112, full text queue database 1146 is connected to a full text parser 1156 which is, in turn, connected to an elastic search engine 1166. Nvidia graphic processing units (GPU) 1161-1163 use floating point parallel computations to perform intensive operations such as deep learning and analytics. Recommendation system (RS) 1164 is an information filtering system that seeks to predict the rating or preference a user such as user 521-1 would give to an item. By this, system 1100 of the present invention can match a user profile with his or her preferred dishes. Apple Push Notification Service (APNS) 1165 is a platform notification service enabled system 1100 to send notification data such as badges, sounds, updates, text alerts, etc. to users such as users 521-1 to 521-N. Elastic search engine 1166 is a document-oriented database designed to manage document-oriented or semi-structured database. A database aggregator 1170 includes partitioned leaf databases 1173-1176 which are managed by an aggregator 1172 and a master aggregator 1171 using mem-SQL (structured query language). In many embodiments of the present invention, partitioned leaf databases 1173-1176 are remote leaf databases 522-1 to 522-M in FIG. 5, which enables world-wide food recognition using leaf databases set up in different sections of the world.

Continuing with FIG. 11 and referring back to FIG. 5, in operation, as each users 521-1 to 521-N presses an icon (GUI) on their communication devices 1110 to activate Hatto™ food socio-touristic media 401, a wireless communication channel 1101 establishing a link between Hatto™ webserver 1120 and communication devices 1110. Cloudflare 1111 is a cloud platform operative to provide web performance services and securities among users 521-1 to 521-N. Cloudflare 1111 stops malicious traffic including bad bots and crawlers, hackers and attackers; optimizes content delivery; and routes safe requests through global network such as network 510. Apache2 WSGI module 1121 hosts various web applications and Hatto™ food socio-touristic media 401. In the present disclosure, web applications include interactive contents such as matching and displaying page 542-4, ad pages in Hatto™ food tourism 542-5, and Hatto™ gamification 542-6 where users 521-1 to 521-N interact therewith. WorldPress unit 1123 is an open source content management system (CMS) for building Hatto™ food socio-touristic media 401. Hatto™ food socio-touristic media 401 is supported by more than one backend web servers that use multiple computing resources. In the present invention, there are servers 1125 for blogs, posts, and forums application 541; server 1126 for Hatto™ food tourism 542, server 1127 for Hatto™ gamification 546. Data storage 1128 stores the scripts or codes for these backend servers. Load balancer 1124 efficiently distributes incoming network 510 traffic across backend server 1125-1127 so that users 521-1 to 521-N do not have to wait for his or her Hatto™ 401.

Continuing with FIG. 11 and FIG. 5, after user 521-1 to 521-N has access into Hatto™ 401, he or she can view comments from friends from previous posts, look at the first-level prizes (watermelons) and second-level prizes (the Tam Rice), view the ads, read blogs from friends, chat with friends, send text messages, post an image of food inquiry at his or her personal page, and exchanges or buy discounted products. All of these actions can take place instantaneously at the fingertip of users 521-1 to 521-N without losing any contents and being exposed to illicit contents. This is implemented by methods 300-400 and 600-1000 and Hatto™ web server 1120. The codes for methods 300-400 and 600-1000 are stored in cache memory in cluster of CPU and GPU 541 which is Hatto™ central brain. Food input inquiries are performed by AI lazy predictor queue database 1142, lazy predictor server 1152, and Nvidia GPU 1162 in the fashion described above in FIG. 1 and FIG. 2. After a while, system 1100 learns to connect between user profile and food dishes by means of AI visionary queues database 1141, vision farm server 1151, and first Nvidia GPU 1161. First Nvidia GPU 1161 is programmed to perform real-time automatic customer analysis and solution. For example, first Nvidia GPU 1161 knows which users among users 521-1 to 521-N like hamburgers. Consequently, system 1100 recommends hamburgers to such users at restaurant(s) that user may not know. This is implemented by AI recommender & ADS queue database 1144 via AI recSys & Ads 1153 and third Nvidia GPU 1163. If the search result is found, notification is posted via Apple Push Notification (APN) queue database 1145, PA service server 1155, and Apple Push Notification Service (APNS) 1165. Text searches are parsed and understood by fulltext queue database 1146, fulltext parser 1156, and elastic search engine 1166. Hatto™ data center 533 is a network database (NDB) that includes remote leaf databases 522-1 to 522-M. Remote leaf databases 522-1 to 522-M are represented as leaf databases 1173-1176 which are connected and combined together by a master aggregator 1171 (see masterand an aggregator 1172. In some embodiments of the present invention, some remote leaf databases 522-1 to 522-M belong to certified chefs or super VIP who are approved by the principal artificial intelligence (PAI) in that they can contribute and share their databases with system 1100. In other embodiments of the present invention, remote leaf databases 522-1 to 522-M are located around the world and connected to system 1100 via network 510. It is noted that leaf databases 1173 to 1176 are either in-memory databases or remote databases.

Now referring to FIG. 12A-FIG. 12B, a log-in page and a personal page of Hatto™ food socio-touristic media 401 in accordance with an exemplary embodiment of the present invention are illustrated. After users 521-1 to 521-N have down loaded the Hatto™ application, the log-in page of Hatto™ food socio-touristic media 401 displaying the Hatto™ background appears on a communication device 1210. Communication device 1210 can be either smart phones, laptops, desktops, or tablets. Hatto™ food socio-touristic media 401 begins by a sign-in section 1212. Users 521-1 to 521-N can sign in using either Facebook, Zalo, or personal email addresses. Referring back to FIG. 3, step 301 begins by signing in into Hatto™ food socio-touristic media 401.

In FIG. 12B, after successfully log-in, a personal page 1200B displays a profile section 1220, a recommendation section 1230, current post section 1240, and a task bar 1250. In profile section 1230, username (e.g., “Nguyen Phuong Anh”), profile picture, her title, a total first-level prizes (watermelon) earned 1222, and a total second-level prizes (Tam Rice) earned 1221 are displayed. In recommendation section 1230, pictures and the name of the dishes that are most liked, reacted to, and viewed are displayed in chronological order from left to right. In current post section 1240, images of food dishes, descriptions, comments, and reactions from different users that are friend with the current user are chronologically displayed in top down fashion. In task bar 1250, a home button 1251, a restaurant search button 1252, a camera button 1253, a like button 1254, and a game button 1224 are disposed for use by the primary user, e.g., user 521-1.

Referring next to FIG. 13A-FIG. 13B, a camera application and food inputs in the Hatto™ food socio-touristic media 401 in accordance with an exemplary embodiment of the present invention are illustrated. In FIG. 13A, as primary user (e.g., 521-1, Nguyen Phuong Anh) presses camera button 1253, a message box 1310 including choices of either a “take photo” button 1311 and an “upload photo” button 1312 is displayed. As message box 1310 is displayed, it becomes brighter and personal page 1200B becomes dimmer as the background. If “take photo” button 1311 is selected, Hatto™ food socio-touristic media 401 allows the primary user to take the photo of the food image. If “upload photo” button 1312 is selected, images stored in the memory of communication device 1210 allows the primary user to select a food picture to upload. FIG. 13A illustrates step 303, which is “select application” in FIG. 3. After the primary user choses a food picture, step 304 and step 306 are implemented.

In FIG. 13B, as soon as the food image is uploaded, Hatto™ food socio-touristic media 401 searches Hatto™ data center 533 using artificial intelligence lazy predictor engine 551 operating as described in FIG. 2. This is the implementation of step 308. In many aspects of the present invention, only two food images 1311 and 1312 can be selected and uploaded at a time. Step 311 and step 312 are illustrated as the name of the first dish 1311 (“Fried shrimp”) and that of second dish 1312 (“Stewed Chicken”) are displayed. The name and the address of the restaurant are also shown. Reaction menus 1314 and 1315 for each food dish including thumb up, thumb down, suggest, and love are also attached to each food image 1311 and 1312 respectively. In addition, a similar item 1320 of another restaurant “Gentle Onion” offering the same food dishes is displayed. In similar item 1320, the primary user can either turn it off, find the exact location, or view the picture of the restaurant. At the bottom of communication device 1210, a picture menu 1330 includes a suggest picture button 1331, a draw box button 1332, and an all box button 1333, allowing a user (e.g., Nguyen Phuong Anh, 521-1) to maneuver the photo of a food input inquiry. Suggest picture button 1331 allows the user Nguyen Phuong Anh to post the fried shrimp and stewed chicken pictures as the food input inquiries. Draw box 1332 allows her to select a particular dish (e.g., fried shrimp only) as the food input inquiry. All box button 1333 allows her (Nguyen Phuong Anh) to select all dishes in the picture as the food input inquiries, equivalent to “select all” option that is well-known in the computer art.

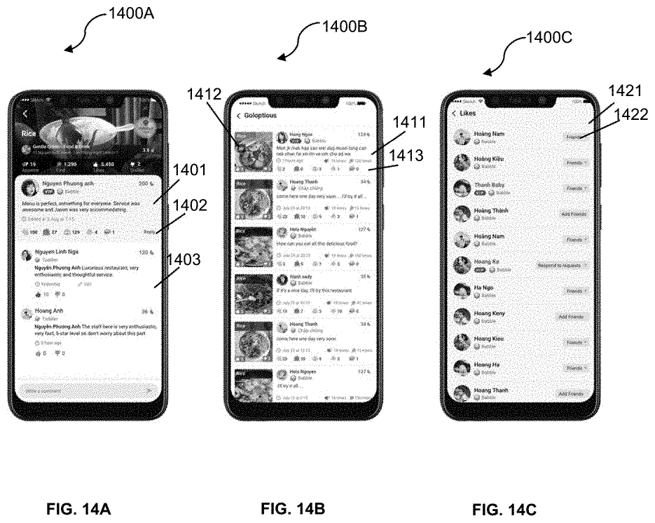

Referring to FIG. 14A-FIG. 14C, primary and secondary user comments and the like pages of the Hatto™ food socio-touristic media 401 in accordance with an exemplary embodiment of the present invention are illustrated. As alluded above, a primary user is the registered owner of his or her personal page. A secondary user is the visitor (or viewer) of the personal page of the primary user. In FIG. 14A, comments 1401 of the primary user (“Nguyen Phuong Anh”) about the restaurant in FIG. 13B are posted. A reaction banner 1402 of the primary user is attached underneath comments 1401. Secondary users comments 1403 such as “Nguyen Linh Nga” and “Hoang Anh” are also displayed. In FIG. 14B, comments of other secondary users 1411 are shown. A picture of the favorite food dish 1412 is also attached to the picture of the secondary user. Reaction banner 1413 for each comment of secondary user is also displayed. In FIG. 14C, a list 1400C of all secondary users who like the primary user (Nguyen Phuong Anh) are listed with a relationship button 1422 are listed one by one. Relationship button 1422 includes “friend”, “respond to request to be friend”, or “add friends”.

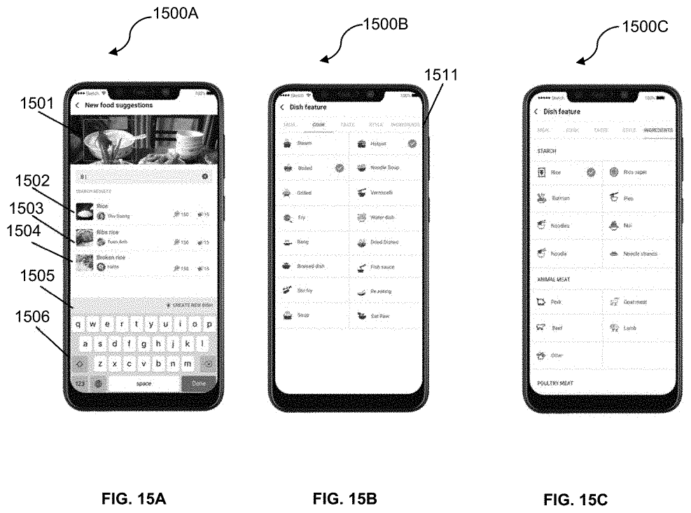

Referring to FIG. 15A-FIG. 15C, the answer pages of human intelligence inputs of Hatto™ food socio-touristic media 401 in accordance with an exemplary embodiment of the present invention are illustrated. FIG. 15A-FIG. 15C illustrate steps 313 and 314 of FIG. 3 when the search from artificial intelligence lazy predictor engine 551 results in a “not found”. In this situation, inputs from the human intelligence contribution of secondary users are sought as discussed in step 313. In FIG. 15A, when the primary user (Nguyen Phuong Anh) selects an unknown dish 1501, there are three answers as illustrated in step 314: a first answer 1502 from secondary user “Thu Suong” declares the food input inquiry is a bowl of rice; a second answer 1503 from another secondary user “Tuan Anh” declares it is a ribs rice; and a third answer 1504 from Hatto indicates it to be a broken rice. A menu 1505 to create another new dish allows the primary user to enter the description of a new dish. A keyboard section 1506 enables the primary user to enter a new dish. In many aspects of the present invention, keyboard section 1506 enables visually impaired users to describe his or her food dishes, which is an implementation of steps 305. In other aspects, a microphone icon is provided so that users can conveniently describe the new dish by voice. This is the implementation of step 309. In FIG. 15B and FIG. 15C, a list of dish features 1511 including meal, cook, taste, style, ingredients, etc. is included to provide the primary user (Nguyen Phuong Anh) with useful information about the input dish 1501. If a cook menu is selected, an instruction is provided to teach the primary user how the input dish 1501 is prepared by either “boiled” or “hotpot.” In FIG. 15C, if an ingredient menu is selected, all ingredients in input dish 1501 are listed. FIG. 15B and FIG. 15C illustrate the implementation of step 312.

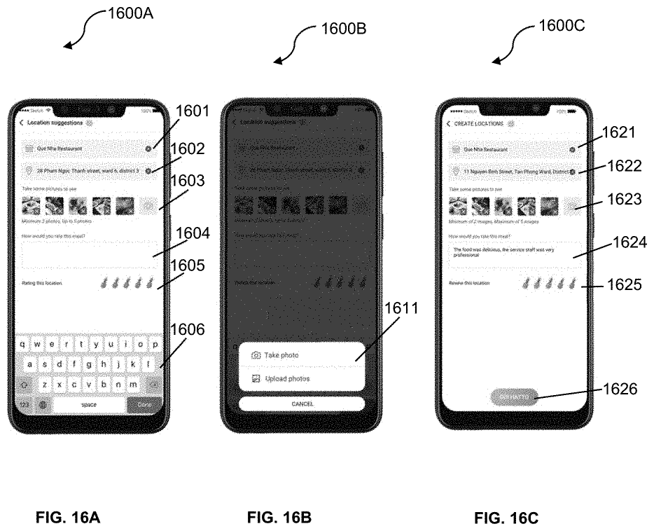

Referring to FIG. 16A-FIG. 16C, the restaurant recommendation and creation pages of the Hatto™ food socio-touristic media 401 in accordance with an exemplary embodiment of the present invention are illustrated. In FIG. 16A, a location recommendation page 1600A is illustrated which includes restaurant name section 1601, a restaurant address 1602, a picture section 1603, a text description section 1604, a rating section 1605, and a keyboard section 1606. The secondary users have to complete location suggestion page 1600A in order to move to location creation page 1600C. The completion of location suggestion page 1600A requires a fill-out of name section 1601, a restaurant address 1602, a picture section 1603, a text description section 1604, and a rating section 1605. Rating section 1605 is completed by touching the pineapple symbols. In FIG. 16B, a photo section 1611 enables the primary user to either take phot or upload photos stored in his or her phone albums. In FIG. 16C, after all information are completed. A restaurant name 1621, a restaurant address 1622, and a picture of the restaurant 1623 are uploaded. Comments 1624 are described, and rating of the restaurant 1625 is selected. As the screen of communication device 1210 changes, a send button 1626 appears in place of keyboard 1606. If the primary user presses send button 1626, the above information will be updated in Hatto™ data storage 533 and Hatto™ neural network 1180 for deep learning analysis. This is the implementation of step 315.

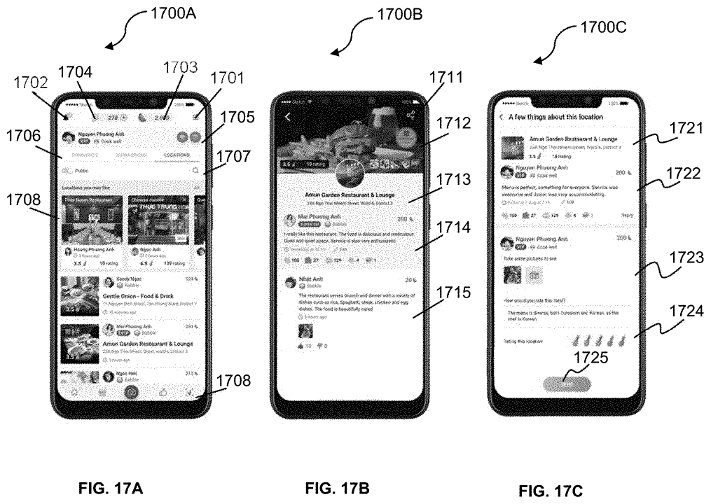

Referring to FIG. 17A-FIG. 17C, forum pages 1700A-1700B of the Hatto™ food socio-touristic media 401 in accordance with an exemplary embodiment of the present invention are illustrated. Forum pages 1700A-1700C illustrate forum section 410 that includes user submissions 411, chat/messages, and food location page 413 in FIG. 4. As discussed above, forum pages 1700A-1700B are part of Hatto™ food socio-touristic media 401 written by WordPress and MySQL application 1123. In FIG. 17A, a personal page 1700A of the primary user (Nguyen Phuong Anh) is displayed after log-in. Personal page 1700A includes a status banner that includes a drop-down menu 1701, a notification button 1702, a first level prize button 1703, and a second level prize button 1704. Drop-down menu 1701 allows the primary user (Phuong Anh Nguyen) to navigate to different applications such as exiting out of Hatto™ food socio-touristic media 401 to answer an incoming phone call. Notification button 1702 informs the primary user that she has new unread messages or posts. First-level prize (watermelons) button 1703 displays the total amount of first-level prize the primary user currently has. Similarly, First-level prize (watermelons) button 1704 displays the total amount of first-level prize the primary user currently has. Personal page 1700A also includes the name of the primary user (Nguyen Phuong Anh), her title as VIP, her skill, and her awards. A comment tab, a submission tab, and a location tab 1706 that enable the primary user to navigate to different categories of her personal page 1700A. Please note that FIG. 17A shows the location tab being selected. Next, the primary can chose to let the public views her posts or search for friends on Hatto™ food socio-touristic media 401. A restaurant location suggestion section 1708 displaying all restaurants recommended by the friends of the primary user. Next, posts 1709 by other users are displayed. The primary user can scroll up or down post 1709 to view more posts. Finally, a utility banner 1708 enables the primary user to go to “home”, find restaurants in food tourism section 430, take a picture, like, or play game. FIG. 17B illustrates the detail post 1700B of a friend of the primary user. For example, the secondary user (Mai Phuong Anh) recommends the “Amun Garden Restaurant and Lounge” on the primary user personal page 1700A. When the primary user touches this post, the detail post page 1700B appears, replacing the original personal page 1700A. FIG. 17B illustrates the implementation of step 312 which is “display the results in Hatto™ food socio-touristic media 401”. Step 312 is coded in matching and displaying subroutine 542-2 of Hatto™ socio-touristic platform web programs 540. Detail restaurant page 1700B includes a share function 1711, the background picture of the restaurant 1712, a name and address of the restaurant 1713, the comment of the user who posts such restaurant 1714, and other comments from other users 1715. In FIG. 17C, a display 1700C of a user comment and rating of a restaurant is displayed. Display 1700C includes a name and address of the restaurant 1721, a comment of other users (Nguyen Linh Nga), a chat box 1723, a rating 1724 by touching the pineapple symbols, and a send button 1725. Thus, if the primary user, Nguyen Phuong Anh, wants to respond to a secondary user, Nhat Anh, she touches on his comment about the Amun Garden Restaurant and Lounge to enter her comment and rating. After that, she can touch send button 1725 to post her comment.

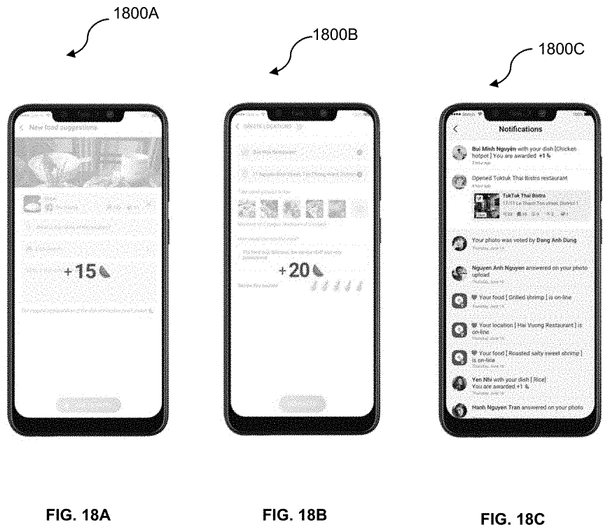

Next, FIG. 18A to FIG. 21C illustrate gamification section 440 of Hatto™ food socio-touristic media 401. Gamification section 440 is implemented by gamification subroutine 542-6 which uses WordPress 1213 as the building software program.

Referring to FIG. 18A-FIG. 18C, first-level prize (watermelon) rewards for different activities 1800A-1800B and notification page 1800C of Hatto™ food socio-touristic media 401 in accordance with an exemplary embodiment of the present invention. In FIG. 18A, 15 first-level prize is awarded to a user for his or her new food suggestions. In FIG. 18B, 20 first-level prize is awarded to this user for his or her creation of a new restaurant. If this user touches on either first-level prize award in 1800A or 1800B, notification page 1800C is displayed which show all rewards to other users for their activities. These are illustrations of first-level prize symbolized as watermelons component 441 of gamification 440. As alluded above, gamification 440 is used to incentivize users to contribute their intelligence to food image recognition process, supplemental to artificial intelligence (AI) lazy predictor engine 551.

Referring to FIG. 19A-FIG. 19C, an exchange and reward notification 1900A-1900C as part of the gamification of the Hatto™ food socio-touristic media 401 in accordance with an exemplary embodiment of the present invention are presented. The gamification as illustrated by FIG. 19A-FIG. 19C is implemented as an integral part of Hatto™ food socio-touristic media 401 which is coded using WordPress software program. More particularly, pages 1900A-1900C are the execution of Hatto™ gamification subroutine 542-6. In FIG. 19A, an exchange page 1900A from the first-level prize (watermelon) to the second-prize level (the Tam Rice) includes a title 1911, a prize status 1912, an exchange calculator 1913, a confirm button 1914, and a purchase section 1916. A user may navigate to exchange page 1911 by touching on any first-level prize symbol on his or her personal page. Currently, prize status 1912 indicates that this user has 2,172 first-level prizes (2,172 watermelons) and 278 second-level prize (278 Tam Rice). Prize status 1912 is an illustration of step 804 in FIG. 8. The user enters the number of first-level prize (watermelon) to exchange for the second-level prize (Tam Rice). If the number of the first-level prize entered is 150, this user will get 10 second-level prize (Tam Rice). If this is what he or she wants, confirm button 1914 should be pressed. This is an illustration of steps 808 and 809 in FIG. 8. In addition, the user can buy second-level prize (Tam Rice) in purchase section 1916 by enter the amount he or she wants to buy and pay the amount of money indicated below each second-level prize (the Tam Rice). The amount of second-level prize starts with 10 second-level prize (the Tam Rice) and increased by 10. For example, 10 second-level prize (Tam Rice) costs 15.000 VND; next, 100 10 second-level prize (Tam Rice) costs 150.000 VND. The user can select the amount of second-level prize she or he wants to buy by touching each box. In FIG. 19B, the user can also move up by exchanging the second-level prize (Tam Rice). In this situation, if the user touches the second-level prize (Tam Rice) symbol in the prize status 1912, the VIP page 1900B appears replacing the exchange page 1900A. VIP exchange page 1900B includes a title header 1921, a second-level prize (Tam Rice) status 1922, a VIP exchange status 1923, a super VIP (SVIP) chef exchange status 1924, a SVIP special exchange status 1925, and SVIP location exchange status 1926. Referring back to FIG. 10, super VIP level 1002 includes a VIP level 1901, a super VIP specialist 1902, a super VIP restauranteur 1903, and a super VIP chef 1904. VIP level 1003 is illustrated by 1901. These VIP and super VIP levels if approved by primary artificial intelligence (PAI), will receive certified official stamps, 1901 to 1904, next to their name. This is the illustration of steps 1010-1011. In FIG. 19C, the user (Nguyen Phuong Anh) is a VIP user. Thus, the VIP certified official stamp 1901 is stamped next to her profile picture. Her favorite restaurant, Gentle Onion Food & Drink, is shown in her personal background. This restaurant is also a member of Hatto™ food socio-touristic media 401 and is a super VIP chef member with the certified official stamp 1931 which is super VIP chef 1904. It is noted that super VIP members will have perks and privileges such as the rights to modify Hatto™ data center 533 by connecting his or her home hard drive as one of the remote leaf databases 522-1 to 522-M.

Referring to FIG. 20A-FIG. 20C, product purchasing and gift pages 2000A-2000C as part of the gamification of the Hatto™ food socio-touristic media 401 in accordance with an exemplary embodiment of the present invention are illustrated. Product purchasing and gift pages 2000A-2000C can be accessed by pressing a gamification button 2001. This is the illustration of steps 803 to 815 in FIG. 8. In FIG. 20A, a store page 2002 includes a prize status section 2003, a selection menu 2004, a gift selection 2005, and a food and restaurant section 2006. Prize status section 2003 displays total number of first-level prize (watermelons) and second-level prize (Tam Rice) that the user has earned. This is an illustration of step 804. Selection menu 2004 includes products, food and drink, and travel categories. Gift selection 2005 displays gifts or products at discounted prices available to users. Foods and restaurants section 2006 lists foods and restaurants associated with Hatto™ that can offer discounts and free meals to users. If the user selects food and drink in selection menu, page 2000B is displayed and replacing page 2000A. Food and drink button is highlighted and different foods, drinks choices 2012 and restaurants 2013 are displayed for users to select. In FIG. 20C, if the user selects gift selection 2005 and chooses to buy a smartphone, a notification 2021 announcing that this smart phone costs 150 second-level prize (Tam Rice). If the user has 278 second-level prize (Tam Rice), he or she can buy this phone without spending any out-of-pocket money. If this user does not have 150 second-level prize, he or she can exchange the first-level prize to second-level prize and/or buy second-level prize.

Finally referring to FIG. 21A-FIG. 21C, QR codes in the product purchasing pages 2100A-2100C of the Hatto™ food socio-touristic media 401 in accordance with an exemplary embodiment of the present invention are illustrated. The gamification as illustrated by FIG. 21A-FIG. 21C is implemented as an integral part of Hatto™ food socio-touristic media 401 which is coded using WordPress software program. More particularly, pages 2100A-2100C are the execution of Hatto™ gamification subroutine 542-6. In FIG. 21A, a QR code generation page 2100A from the second-level prize is displayed that includes a title section 2101, a menu section 2102, and a list 2103. In title section 2101, a QR code encoding the number of second-level prize is generated so that the user can scan this at restaurants that associates with Hatto™. This way, when the user go to these restaurants, he or she does not have to pay by money or credit cards. This QR code can be scanned at the purchase of the meal. Menu section 2102 allows the user to either generate a new QR code, receive a QR code from a friend, or retrieve an old QR code generated before to use or update. In FIG. 21B, if the user selects to generate a new QR code for 150 second-level prize (the Tam Rice), a QR code generation page 2100B is displayed replacing page 2100A. QR code generation page includes a title section 2111, a display 2112, and a numeric touch keyboard 2103. The user can enter the amount of second-level prize (Tam Rice) that she or he wants to generate QR code to be used. When a “done” button is pressed, QR code 2100C is displayed in FIG. 21C. QR code 2100C has the value of 150 of second-level prize (Tam Rice). The user can open his or her smartphone, retrieve this QR code of 150 second-level prize and purchase meals or buys products without using credit cards or cash money.

The above disclosure with reference to FIG. 1 to FIG. 21 discloses the following features of the present invention: (1) a system for rendering a socio-touristic media platform that uses the novel Hatto™'s food recognition method, (2) a method for food recognition that uses artificial intelligence (AI) lazy predictor and human intelligence from the social media that provides deep learning platform supplemental to the AI lazy predictor, and (3) a socio-touristic media platform using (1) and (2) that can promote food tourism, commerce, and social network.

The computer program instructions such as 100 and 1000 may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The disclosed flowchart and block diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### DESCRIPTION OF NUMERALS

401 Hatto™ food socio-touristic media (“Hatto™”)
410 forum page of Hatto™
411 user submissions section of Hatto™
412 chat and messes section of Hatto™
413 food location section of Hatto™
420 social network page of Hatto™
421 firewall
422 fan-page
423 update friends
424 friend list
425 display options
426 alert option
430 food tourism page
431 welcome page
432 inquiries
433 local dishes and restaurants
440 gamification page
441 first-level prize (watermelons)
442 second-level prize (Tam Rice)
443 VIP level
444 Super VIP (SVIP) level
445 Exchange function
446 upgrade function
447 gift function
449 discounts/deals function
500 hardware structure of Hatto™
510 network
511 web server gateway interface and firewalls
521-1 a user of Hatto™
521-2 a user of Hatto™
521-3 a user of Hatto™
521-N a user of Hatto™
522-1 a remote leaf database
522-2 a remote leaf database
522-3 a remote leaf database
522-M a remote leaf database
530 Hatto™ hardware system
531 Network I/O interface managed by Cloudflare
532 master aggregator
533 Hatto™ data center
540 Hatto™ central brain
541 Cluster of CPU and GPU
542 Hatto™ socio-touristic media software program
542-1 blogs, posts, and forums subroutines
542-2 VIP member authentication subroutine
542-3 social network subroutine
542-4 matching/displaying subroutine
542-5 food tourism subroutine
542-6 gamification subroutine
550 Hatto™ neural network
551 AI lazy predictor
552 deep learning engine
553 visionary and recommendation
554 search and notification engine
561 wireless communication
1100 hardware and software structure of Hatto™
1101 wireless communication channel
1110 user to Hatto™ as in 521-1 to 521-N
1120 Hatto™ webserver
1111 cloudflare
1112 firewall
1121 Apache2 web server and gateway interface
1122 Hatto™ central brain
1123 WordPress and MySQL applications
1124 load balancer
1125 web serve group 1
1126 web serve group 2
1127 web serve group 3
1128 Hatto™ data center managed by MySQL Cluster
1131 network database (NDB) API
1132 SQL node
1133 management node (MGM-node)
1135 data nodes
1135-1 data node 1
1135-2 data node 2
1180 Hatto™ neural network
1141 AI visionary queues database
1142 AI predictor queue database
1143 AI lazy validator queue database
1144 AI lazy recommender& ADS queue database
1145 APN queue database
1146 fulltext queue database
1151 AI vision farm server
1152 AI lazy predictor server
1153 lazy validator server
1154 AI RecSys & Ads server
1155 PA service server
1156 fulltext parser server
1161 AI vision farm GPU
1162 Lazy predictor GPU
1163 AI lazy validator GPU
1164 Hatto™ recommendation system (RS)
1165 Apple push notification service (APNS)
1166 elastic search engine
1170 database aggregator
1171 master aggregator
1172 aggregator
1173 remote leaf database
1174 remote leaf database
1175 remote leaf database
1176 remote leaf database

1. A system for a food socio-touristic media platform, comprising:
a data center configured to store a set of N known food dishes, where N is a non-zero integer;
a web server capable of launching said food socio-touristic media platform to a plurality of users;
a computing engine further configured to receive food inputs from said plurality of users and perform a lazy predictor algorithm to identify and post said food inputs and related parameters which include similar food dishes, a group of users who also like said food inputs and said similar food dishes, and restaurants that offer said food inputs and said similar food dishes in said food socio-touristic media platform;
wherein said computing engine is configured to receive identification from said plurality of users regarding unknown food inputs which are not identified by said lazy predictor algorithm and update said group of N known food dishes so that said unknown food inputs and related parameters are identified next time said food inputs are received by said web server via said food socio-touristic media platform; and wherein said computing engine further comprises a gamification unit configured to giving different levels of rewards so as to encourage said plurality of users for participating and for providing said identification in said food socio-touristic media platform.

2. They system of claim 1 wherein said lazy predictor algorithm further comprises:
calculating Euclidean distances for said food inputs in an N^{th} dimensional space formed by said group of N known food dishes; finding of food dishes among said group of known food dishes that are closest in said Euclidean distances to said food inputs; and
finding said related parameters including said similar food dishes, said group of users who also like said food inputs and said similar food dishes, and said restaurants that offer said food inputs and said similar food dishes.

3. The system of claim 1 wherein said food inputs further comprise images, voice descriptions, and text descriptions.

4. The system of claim 3 wherein said computing engine further comprises a speech recognition device, a natural language processor, a full-text parser, and a recommendation engine configured to provide said related items to said food inputs.

5. The system of claim 1 wherein said computing engine further comprises a deep learning framework, a feature extractor indexer, and a database server.

6. The system of claim 5 wherein said deep learning framework is configured to increase said set of N known food dishes by adding said unknown food inputs that are identified by said plurality of users into said set of N known food dishes.

7. The system of claim 1 further comprising:
a network configured to connect said plurality of users to said computing engine and said web server;
a multiple central processing units and graphic processing units (GPU); and
a plurality of input/output network interfaces configured to connect said a plurality of central processing units and graphic processing units (GPU) to said network.

8. The system of claim 5 wherein said network comprises a cloud based network, a local area network (LAN), and a wide area network (WAN).

9. The system of claim 5 further comprising:
a plurality of gateway interfaces configured to connect said plurality of users to said network; and
a plurality of security firewalls configured to protect said computing engine from malwares and unwanted contents.

10. The system of claim 1 wherein said web server further comprises a memory configured to store a food socio-touristic media software program, when executed by said multiple central processing units, operative to perform the following steps:
start a forum where said plurality of users are enabled to exchange chat messages regarding said food inputs and related parameters;
start a social network where said plurality of users are enabled to maintain and update friend lists, to receive display options, and to notify alert options;
start a food tourism where said plurality of users are enabled to receive recommendations from said computing engine, and/or receive answers from either said plurality of users or said computing engines; and
start a gamification where said plurality of users are incentivized to participate and to provide answers to said food inputs and related parameters, wherein said gamification is configured to allowing said plurality of users to exchange and/or use said rewards to buy products or obtain discounts in said restaurants.

11. A method of identifying unknown food dishes, comprising:
storing a set of N known food dishes and related parameters which include similar food dishes, a group of users who also like said unknown food inputs and said similar food dishes, and restaurants that offer said unknown food dishes and said similar food dishes in a database;
building a social media platform configured to connect a plurality of users together;
calculating distances for said unknown food dishes and said N known food dishes and said related parameters in an N coordinate space formed by said N known food dishes;
selecting only distances of said N known food dishes and said related parameters that are closest to those of said unknown food dishes;
posting said unknown food dishes in said social media in order to ask said plurality of users to identify said unknown food dishes;
increasing said set of N known food dishes to include said unknown food dishes that are identified by said plurality of users; and
giving said plurality of users who identifies said unknown food dishes with different rewards designed to buy products and obtain discounts in restaurants.

12. The method of claim 11 further comprising incentivizing said plurality of users to provide said answers to said unknown food dishes by rewarding said plurality of users with a first type of prize who provide said answers to said unknown food dishes.

13. The method of claim 11 wherein said incentivizing said plurality of users to provide said answers to said unknown food dishes further comprises removing said first type of prize from said plurality of users who provide said answers to said unknown food dishes that are not approved and not added to said set of N known food dishes.

14. The method of claim 11 wherein said incentivizing said plurality of users to provide said answers to said unknown food dishes comprises allowing said plurality of users to exchange said first type of prize to a higher second type of prize.

15. The method of claim 11 further comprising associating said unknown food dishes and said set of N known food dishes with related parameters which include similar food dishes, a group of users who also like said food inputs and said similar food dishes, and restaurants that offer said food inputs and said similar food dishes.

16. A socio-touristic media platform, comprising:
a forum where said plurality of users are enabled to post questions regarding food inputs and related parameters which include similar food dishes, a group of users who also like said food inputs and said similar food dishes, and restaurants that offer said food inputs and said similar food dishes;
a social network where said plurality of users are enabled to maintain and update friend lists, to receive display options, and to notify alert options;
a food tourism where said plurality of users is enabled to receive recommendations and/or receive answers from either said plurality of users or computing engines;
a gamification where said plurality of users is incentivized to provide answers to said food inputs and related parameters, wherein said gamification is configured to give said plurality of users who identifies said unknown food dishes with different rewards designed to buy products and obtain discounts in restaurants.

17. The socio-touristic media platform of claim 16 further comprises an interface application configured to connect to a computing engine operative to receive said food inputs from said plurality of users and perform a lazy predictor algorithm to identify said food inputs and said related parameters; and
said computing engine receives and posts said answers from said plurality of users in said forum and said social media and update said group of N known food dishes so that said food inputs and related items are found next time said food inputs are received.

18. The socio-touristic media platform of claim 17 wherein said lazy predictor algorithm further comprises:
calculating Euclidean distances for said food inputs and related parameters in an N^{th} dimensional space formed by said group of N known food dishes; and
finding K nearest-neighbor (K-NN) of food dishes among said group of known food dishes that are closest in said Euclidean distances to said food inputs; and
finding K nearest-neighbor (K-NN) of related parameters that are closest in said Euclidean distances to said food inputs.

19. The socio-touristic media platform of claim 16 wherein said gamification further comprises:
incentivizing said plurality of users to provide said answers to said food inputs by rewarding said plurality of users with a first type of prize who provide said answers to said food inputs that are approved and added to said set of N known food dishes; and
incentivizing said plurality of users to provide said answers to said food inputs further comprises removing said first type of prize from said plurality of users who provide said answers to said unknown food dishes that are not approved and not added to said set of N known food dishes.

20. The socio-touristic media platform of claim 19 wherein said incentivizing said plurality of users to provide said answers to said unknown food dishes further comprises:
allowing said plurality of users to exchange said first type of prize to a higher second type of prize; and
allowing said plurality of users to purchase discounted products and to use as discounts in restaurants using said first type of prize and said second type of prize.
